(19) United States
(12) Patent Application Publication
(10) Pub. No.: US 2026/0100901 A1
(43) Pub. Date: Apr. 9, 2026

(54) DETERMINING END-TO-END NETWORK LATENCY USING AN EMBEDDED OVERLAY ON A NETWORK CONTROL PROTOCOL

(71) Applicant: Nokia Solutions and Networks Oy, Espoo (FI)

(72) Inventor: Pranjal Kumar DUTTA, Sunnyvale, CA (US)

(21) Appl. No.: 19/006,866

(22) Filed: Dec. 31, 2024

Related U.S. Application Data
(63) Continuation-in-part of application No. 18/909,756, filed on Oct. 8, 2024.

(51) Int. Cl. H04L 43/0864; H04L 43/106

(52) U.S. Cl. CPC H04L 43/0864; H04L 43/106

(57) ABSTRACT

The concept of using an overlay protocol packet embedded as the payload in a network control protocol to measure and calculate the overall, end-to-end latency of network control protocol messages between two nodes in a network is introduced. Example embodiments can be used as a generic solution to efficiently determine the overall, end-to-end latency of almost any network control protocol. By embedding an overlay protocol packet inside a network control protocol, the embedded overlay protocol packet travels the same path and experiences the same network conditions (latency, etc.) as any other network control protocol message. Thus, the measured/calculated latency accounts for any “host” layer latencies not normally captured by tools that merely measure the “IP” latency (i.e. the latency of network control protocol packets from the “IP” layer of one network node to the “IP” layer of another network node).

### CROSS-REFERENCE TO RELATED APPLICATION

This application is a continuation-in-part of U.S. patent application Ser. No. 18/909,756, filed on Oct. 8, 2024, and titled EMBEDDED PROTOCOL OVERLAY ON A NETWORK CONTROL PROTOCOL, which is hereby incorporated by reference herein in its entirety.

### TECHNICAL FIELD

Various example embodiments relate to the field of network protocols tools and, more particularly, to tools for measuring latency in an Internet Protocol (IP) network.

### BACKGROUND

Network management is the process of administering and managing computer networks. Network administrators are typically responsible for the upkeep, configuration, and reliable operation of networks and networking equipment. Network administrators typically monitor various network performance metrics to ensure that a network is efficiently and reliably operating. Latency, as well as packet loss and jitter, are network performance metrics that can offer insights into the quality of a network connection. Latency refers to the time it takes for data packets to travel from a source to a destination. High latency can cause delays in data transmission resulting in irregular arrival intervals and increasing jitter. By monitoring and analyzing these network performance metrics, network administrators can identify and resolve performance issues, to ensure a seamless and reliable user experience.

Various tools currently exist for measuring latency. The Internal Control Message Protocol (ICMP), the One-Way Active Measurement Protocol (OWAMP), and the Two-Way Active Measurement Protocol (TWAMP) are examples of network protocols which provide network latency measurement tools. For example, ICMP, which traditionally runs atop the OSI Network layer, can be used to test Internet Protocol (IP) connectivity among two routing nodes in an IP network. In this case, a first node sends an ICMP echo request message to a second node and encodes a timestamp at the time the ICMP echo request message is dispatched. Upon receiving the ICMP echo request message, the second node sends an ICMP echo reply message back to the first node. When the first node receives the ICMP echo reply message, it can calculate the round-trip (two-way) network latency by determining the difference between the time the ICMP echo request message was dispatched and the time the ICMP echo reply message was received by the first node.

Network protocols are sets of rules that define the communication of data between various devices in a network. These protocols define guidelines and conventions for transmitting and receiving data, ensuring efficient and reliable data communication. While it is possible to write a single protocol that takes data from an application on one device and sends it to an application on another device, this approach is very inflexible. Instead, the approach typically used in networking is to split up the various tasks required to communicate data by creating a variety of protocols which each perform a particular function and which can work together, typically in a layered fashion, to provide a more flexible communication framework.

Network protocols are generally configured to perform secured connections, network management, and network communication functions and, as such, are broadly classified into four major categories: network security, network OAM (operations, administration and maintenance), network control, and network communication. Very generally, network security protocols are designed to protect the confidentiality and authenticity of data as it traverses a network. They establish secure channels for communication and make sure that sensitive information is not vulnerable to interception or tampering. Network OAM protocols can be used for the administration, monitoring, and control of network devices and resources. They help network administrators configure and troubleshoot network components efficiently. Network control protocols establish channels/paths across a network for data communication. They enable network nodes to dynamically manage network resources, distribute routing information, and set up optimal loop-free paths across a network. Finally, network communication protocols enable the exchange of data and information between devices on a network. They determine how data is formatted, transmitted, and received, which ensures effective communication.

Several models exist which organize the set of network protocols used by networks according to a functional criterion. The Open Systems Interconnection (OSI) model is a 7-layer architecture with each layer having specific functionality to perform. The layers work collaboratively to transmit data from one device to another on a network. The 7-layers comprise the: Application layer, Presentation layer, Session layer, Transport layer, Network layer, Data Link layer, and Physical layer. The TCP/IP (Transport Control Protocol/Internet Protocol) model is another framework for organizing network protocols. The TCP/IP model consists of 4 layers. They are the: Application layer, Transport layer, Internet layer, and Network Access layer. In the TCP/IP model, the Application, Presentation, and Session layers of the OSI model are combined into the TCP/IP model Application layer; the TCP/IP model Transport layer corresponds to the OSI model Transport layer, the TCP/IP Internet layer corresponds to the OSI Network layer, and the Physical and Data Link layers of the OSI model are combined into the TCP/IP Network Access layer. The OSI model is a conceptual framework that is typically not fully implemented by modern protocols, whereas the TCP/IP model is a practical implementation.

A protocol suite or family is a collection of protocols that are designed to work together to allow devices to communicate with each other over a network. A protocol stack or network stack is an implementation of a networking protocol suite or protocol family. While some of these terms are used interchangeably, strictly speaking, a collection of the communication protocols is a suite, and a software implementation of the protocol suite is a stack. The approach used in networking today is to create protocol suites implemented as layered protocol stacks in which each level of the stack performs a particular function and communicates with the levels above and below it.

The Internet protocol suite, also commonly referred to as TCP/IP, is one of the most commonly used network protocol suites. TCP/IP consists of many protocols that operate at one of the 4 layers of the TCP/IP model. It draws its name from the foundational protocols used in the suite: the Transport Control Protocol (TCP) and the Internet Protocol (IP). The TCP operates at the Transport layer and the IP operates at the TCP/IP Internet layer (OSI Network layer). TCP/IP was designed to be independent of networking hardware and should run across any connection media, one of the earliest and most common being Ethernet. Ethernet is a 2-layer protocol/standard covering the OSI Physical and Data Link layers (which corresponds to the Network Access layer in the TCP/IP model).

When two devices communicate across a network, the data must travel through various items of networking equipment. This networking equipment is commonly referred to by the OSI level in which the equipment operates. For example, a network router is an example of networking equipment that operates at the OSI Network layer and, as such, is commonly referred to as a level 3 device because the OSI Network layer is the third layer of the OSI model. Similarly, a switch, which operates at the OSI Data Link layer, is referred to as a level 2 device because the OSI Data Link layer is the second layer of the OSI model. Because a router operates at the Network layer (Internet layer of the TCP/IP model), it typically doesn't support upper layer application protocols operating in the OSI Application, Presentation, and Session layers (the TCP/IP Application layer). A router works on network addresses which are part of the Network protocol (IP in the TCP/IP protocol suite). A router can route many different protocols at the same time, but it typically doesn't do protocol conversion. In other words, an IP packet coming in will be an IP packet going out. Likewise, a switch doesn't have OSI level 3, 4, 5, 6, or 7 protocol stacks as it doesn't need them. A switch typically doesn't care about the routing protocol or the application protocol that passes through it. Because a switch operates at OSI level 2 (the Data Link layer) it only needs to understand the MAC addresses that are part of the Ethernet protocol.

While ICMP, OWAMP, and TWAMP latency measurement tools can be useful for testing IP connectivity, this node-to-node latency measurement is only part of the overall, end-to-end latency experienced by a data packet because it starts and ends at both routers OSI Network layer (TCP/IP Internet layer). Many network control protocols, such as Boarder Gateway Protocol (BGP), Label Distribution Protocol (LDP), Open Shortest Path First (OSPF), Intermediate System-Intermediate System (IS-IS), Resource Reservation Protocol-Traffic Engineering (RSVP-TE), and the like, can suffer additional “host” layer latencies, such as OSI Transport, Session, Presentation, and Application layer latencies, which are left unaccounted for in a node-to-node, IP (OSI Network layer) latency measurement. As an example, BGP is a TCP based protocol and can suffer from TCP slow peering problems, such as when a slower BGP peer causes significant backpressure on transmission of BGP packets from another BGP peer. When this happens, the unaccounted-for “host” layer latencies may add significant overhead thus affecting the overall, end-to-end latency. In this case, the unaccounted for “host” layer latencies may make the latency measurements made by traditional, none-to-node latency measurements tools no longer an accurate enough measure of the overall latency of a BGP protocol packet.

In addition to offering an incomplete latency measurement, some node-to-node latency measurement tools suffer from additional short comings. For example, for security reasons, ICMP packets may be blocked by an intermediate firewall. In this case, a target may never respond to an ICMP echo request leaving the user unable to measure the network latency. Furthermore, ICMP protocol messages may be handled with low priority by intermediate routers, further distorting the accuracy of the latency measurements. Instead, a generic solution that can efficiently measure the overall, end-to-end latency of any network control protocol would be more useful.

### SUMMARY

This section introduces aspects that may help facilitate a better understanding of the disclosure. Accordingly, the statements of this section are to be read in this light and are not to be understood as admissions about what is in the prior art or what is not in the prior art.

Example embodiments described in the subject disclosure introduce the concept of embedding an overlay protocol that traditionally runs in a first Open Systems Interconnection (OSI) layer, typically corresponding to a network OAM protocol that provides a latency measurement tool, in the network control protocol used by the network for data communications which traditionally runs in a second OSI layer different from the first OSI layer. In various embodiments, an embedded overlay protocol packet can be carried as the payload in a network control protocol message sent from one network device to another. While processing the message, the network control protocol of the receiving network device can be configured to recognize that the payload of the message is an embedded overlay protocol packet that traditionally runs in a different OSI layer than the network control protocol, open up an instance of the embedded overlay protocol at the network control protocol OSI layer, and use the opened instance of the embedded overlay protocol to process the embedded overlay protocol message. Because the embedded overlay protocol message is carried as part of the payload of the network control protocol message, it travels the same path and experiences the same network conditions as other network control protocol messages. As such, implementations of the network control protocol message with an embedded overlay protocol can be used in various embodiments to enable an efficient, generic mechanism for measuring various network performance metrics such as the overall, end-to-end latency of packets (including the previously unaccounted-for “host” layer latencies) in a network with precision.

In the example embodiments, the network control protocol comprises Border Gateway Protocol (BGP), however, numerous other network control protocols can used without departing from the concepts and principles of the subject disclosure. For example, network control protocols such as LDP, OSPF, IS-IS and RSVP-TE to name a few, can be used in place of BGP. The various embodiments provide methods and apparatus for calculating latency between a first node and a second node running a network control protocol. The first node and the second node can be configured to send and receive a network control protocol message across a network. At the first node, calculating latency according to various example embodiments described herein can involve embedding an overlay protocol message as the payload of a network control protocol message to produce an embedded overlay protocol message, sending the embedded overlay protocol message from the first node through the network to the second node, and recording a sent time (T1) indicative of the time the embedded overlay protocol message was sent.

At the second node, calculating latency according to various example embodiments described herein can involve receiving the embedded overlay protocol message sent by the first node and processing the embedded overlay protocol message using an instance of the overlay protocol embedded in the network control protocol at the second node, the embedded overlay protocol instance being configured to process the embedded overlay protocol message. Also, in response to receiving the embedded overlay protocol message from the first node, the second node embeds an overlay protocol reply message as the payload to a second network control protocol message to produce an embedded overlay protocol reply message and sends the embedded overlay protocol reply message from the second node through the network to the first node.

The first node, after receiving the embedded overlay protocol reply message from the second node, processes the embedded overlay protocol reply message using an instance of the overlay protocol embedded in the network control protocol at the first node, records a received time (T2) indicative of the time the embedded overlay protocol reply message is received by the instance of the overlay protocol embedded in the network control protocol at the first node, and calculates the latency based on the difference between the received time (T2) and sent time (T1).

In some embodiments, calculating the latency further comprises dividing the difference between the received time (T2) and the sent time (T1) by two to determine an estimation of the one-way latency between the first and second nodes. A variety of difference embedded overlay protocols, embedded overlay protocol messages, and embedded overlay protocol reply messages can be used to calculate latency. For example, the embedded overlay protocol can comprise Internet Control Message Protocol (ICMP), the embedded overlay protocol message can comprise an ICMP Echo Request message, and the embedded overlay protocol reply message can comprise an ICMP Echo Reply message.

In another embodiment in which the embedded overlay protocol comprises Internet Control Message Protocol (ICMP), the embedded overlay protocol message can further comprise an ICMP Timestamp message and the embedded overlay protocol reply message can further comprise an ICMP Timestamp Response message. In this embodiment, the two-way latency of a network control protocol message from the first node to the second node and back to the first node can be calculated by subtracting the difference between the time the ICMP Timestamp Response message is sent by the second node from a time the ICMP Timestamp message is received by the instance of ICMP embedded in the network control protocol at the second node from the difference between the received time (T2) and the sent time (T1).

In still another example embodiment in which the first node and the second node are time synchronized, the embedded overlay protocol can further comprise Two-Way Active Measurement Protocol (TWAMP), the embedded overlay protocol message can further comprise a TWAMP-Test message, and the embedded overlay protocol reply message can further comprise a TWAMP-Test Response message. In this embodiment, the two-way latency of a network control protocol message from the first node to the second node and back to the first node can be calculated by subtracting the difference between the time the TWAMP-Test Response message is sent by the second node from a time the TWAMP-Test message is received by the instance of TWAMP embedded in the network control protocol at the second node from the difference between the received time (T2) and the sent time (T1).

Additional example embodiments provide methods and apparatus for calculating one-way latency between a first node and a second node running a network control protocol in which the first node is configured to send and the second node is configured to receive a network control protocol message across a network. In these embodiments, the first node and second node are time synchronized. The first node can be configured to embed an overlay protocol message as the payload of a network control protocol message to produce an embedded overlay protocol message, encode the embedded overlay protocol message with a sent time (T1) indicative of a time the embedded overlay protocol message was sent, and send the embedded overlay protocol message from the first node through the network to the second node.

Upon receiving the embedded overlay protocol message, the second node can be configured to process the embedded overlay protocol message using an instance of the overlay protocol embedded in the network control protocol opened at the second node. The embedded overlay protocol can be configured to process the embedded overlay protocol message, record a received time (T2) indicative of a time the embedded overlay protocol message is received by the instance of the overlay protocol embedded in the network control protocol at the second node, and calculate the one-way latency based on the difference between the received time (T2) and sent time (T1).

A variety of difference embedded overlay protocols and embedded overlay protocol messages can be used to calculate latency. For example, the embedded overlay protocol can comprise the One-Way Active Measurement Protocol (OWAMP) and the embedded overlay protocol message can comprise an OWAMP-Test message. Alternatively, the embedded overlay protocol can comprise Two-Way Active Measurement Protocol (TWAMP) and the embedded overlay protocol message can comprise a TWAMP-Test message. In still other embodiments, the embedded overlay protocol can comprise Internet Control Message Protocol (ICMP) and the embedded overlay protocol message can comprise an ICMP Timestamp message. The network control protocol comprises Border Gateway Protocol (BGP), however, numerous other network control protocols can used without departing from the concepts and principles of the subject disclosure. For example, network control protocols such as LDP, OSPF, IS-IS and RSVP-TE to name a few, can be used in place of BGP.

The example embodiments include a network node in communication with a second node across a network, with the network node running the network control protocol and an instance of the overlay protocol embedded in the network control protocol. The network node can comprise a processor and memory including program code. The memory and program code, with the at least one processor, can be configured to cause the network node embed the overlay protocol message as the payload to a network control protocol message to produce an embedded overlay protocol message, record a sent time (T1) indicative of the time the embedded overlay protocol message was sent from the network node to the second node, and send the embedded overlay protocol message from the network node through the network to the second node. When the network node receives an embedded overlay protocol reply message sent by the second node in response to it receiving the embedded overlay protocol message from the network node, the network node can be configured to process the embedded overlay protocol reply message using the instance of the overlay protocol embedded in the network control protocol at the network node, record a received time (T2) indicative of the time the embedded overlay protocol reply message was received by the instance of the overlay protocol embedded in the network control protocol at the network node, and calculate the latency between the network node and the second node based on the difference between the received time (T2) and sent time (T1). The latency can be made to represent an estimation of the one-way latency between the network node and second node by dividing the difference between the received time (T2) and the sent time (T1) by two.

A variety of different embedded overlay protocols, embedded overlay protocol messages, and embedded overlay protocol reply messages can be used to calculate latency. For example, the embedded overlay protocol can comprise Internet Control Message Protocol (ICMP), the embedded overlay protocol message can comprise an ICMP Echo Request message, and the embedded overlay protocol reply message can comprise an ICMP Echo Reply message. Alternatively, the embedded overlay protocol can comprise Two-Way Active Measurement Protocol (TWAMP), the embedded overlay protocol message can comprise a TWAMP-Test message, and the embedded overlay protocol reply message can comprise a TWAMP-Test Response message. In yet another example embodiment, the embedded overlay protocol can comprise the Internet Control Message Protocol (ICMP), the embedded overlay protocol message can comprise an ICMP Timestamp message, and the embedded overlay protocol reply message can comprise an ICMP Timestamp Response message. The network control protocol can comprise the Border Gateway Protocol (BGP), however, numerous other network control protocols can used without departing from the concepts and principles of the subject disclosure. For example, network control protocols such as LDP, OSPF, IS-IS and RSVP-TE to name a few, can be used in place of BGP.

In other embodiments, the network node is time synchronized with the second node and is configured to receive an embedded overlay protocol message from the second node, the embedded overlay protocol message comprising an overlay protocol message embedded as the payload to a network control protocol message, the overlay protocol message being encoded with a sent time (T1) indicative of a time the second node sent the embedded overlay protocol message to the network node. The network node can be configured to record a received time (T2) indicative of the time the embedded overlay protocol reply message is received by the instance of the overlay protocol embedded in the network control protocol on the network node and calculate the one-way latency based on a difference between the received time (T2) and sent time (T1).

The embedded overlay protocol can comprise: One-Way Active Measurement Protocol (OWAMP) with the embedded overlay protocol message comprising an OWAMP-Test message; Two-Way Active Measurement Protocol (TWAMP) with the embedded overlay protocol message comprising a TWAMP-Test message; Internet Control Message Protocol (ICMP) with the embedded overlay protocol message comprising an ICMP Timestamp message, or a variety of other embedded overlay protocols and/or embedded overlay protocol messages. The network control protocol can comprise Border Gateway Protocol (BGP) or any number of other network control protocols such as LDP, OSPF, IS-IS and RSVP-TE to name a few.

One or more of the above embodiments may be combined as desired.

The above summary provides a basic understanding of some aspects of the specification. This summary is not an extensive overview of the specification. It is intended to neither identify key nor critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some example embodiments are now described, by way of example only, and with reference to the accompanying drawings. The same reference number represents the same element or the same type of element on all drawings.

FIG. 1 is a schematic diagram of a network depicting single-hop and multi-hop BGP sessions between routers.

FIG. 2 is a schematic diagram of two BGP peer routers in communication over a network.

FIG. 3 is a schematic diagram of two BGP peer routers in communication over a network implementing an embedded overlay protocol according to an example embodiment of the subject matter described herein.

FIG. 4 is a schematic diagram of a fixed sized header of a BGP packet.

FIG. 5 is a schematic diagram of an overlay protocol message format according to some embodiments of the disclosure.

FIG. 6 is a schematic diagram of a partially populated overlay protocol message format according to various embodiments.

FIG. 7 is a schematic diagram of a partially populated overlay protocol message format according to some embodiments described herein.

FIG. 8 is a schematic diagram of a partially populated overlay ICMP protocol message format according to embodiments of the disclosure.

FIG. 9 is a flow diagram illustrating a method for preparing and transmitting an overlay protocol embedded in a BGP packet according to an example embodiment of the subject matter described herein.

FIG. 10 is a flow diagram of a method for processing a BGP packet with an embedded overlay protocol according to another embodiment of the subject matter described herein.

FIG. 11 is a schematic diagram of two BGP peer routers in communication over a network implementing an embedded overlay protocol according to another example embodiment of the subject matter described herein.

FIG. 12 is a schematic diagram of a partially populated overlay ICMP Timestamp message format according to embodiments of the disclosure.

FIG. 13 is a schematic diagram of a partially populated overlay ICMP Timestamp Reply message format according to embodiments of the disclosure.

FIG. 14 is a schematic diagram of two BGP peer routers in communication over a network implementing an embedded overlay protocol according to another example embodiment of the subject matter described herein.

FIG. 15 is a schematic diagram of a partially populated overlay TCP connection establishment packet format according to embodiments of the disclosure.

FIG. 16 is a schematic diagram of a partially populated overlay Server Greeting message format according to embodiments of the disclosure.

FIG. 17 is a schematic diagram of a partially populated overlay Set-Up-Response message format according to embodiments of the disclosure.

FIG. 18 is a schematic diagram of a partially populated overlay Server-Start message format according to embodiments of the disclosure.

FIG. 19 is a schematic diagram of a partially populated overlay OWAMP-Test message format according to embodiments of the disclosure.

FIG. 20 is a schematic diagram of the Timestamp field in an OWAMP-Test message.

FIG. 21 is a schematic diagram of the Error Estimate field in an OWAMP-Test message.

FIG. 22 is a schematic diagram of a partially populated overlay TWAMP-Test-Response message format according to embodiments of the disclosure.

### DESCRIPTION OF EMBODIMENTS

In the following description, for purposes of explanation and not limitation, specific details are set forth, such as particular protocols, messages and message formats, networks, peering sessions, techniques, etc., in order to provide a thorough understanding of the present invention. However, it will be apparent to one skilled in the art that the present invention may be practiced in other embodiments that depart from these specific details. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future.

Note that as used herein, the terms “first”, “second” and so forth are not intended to imply sequential ordering, but rather are intended to distinguish one element from another, unless explicitly stated. Similarly, sequential ordering of method steps does not imply a requirement of sequential order of their execution, unless explicitly stated. The term “connected” may encompass direct connections or indirect connections through intermediate elements, unless explicitly stated otherwise.

Furthermore, the following abbreviations and acronyms may be used in the present document:
“BGP” Border Gateway Protocol
“MP-BGP Multi-Protocol Border Gateway Protocol
“iBGP” Internal (or Interior) Border Gateway Protocol
“eBGP” External (or Exterior) Border Gateway Protocol
“LDP” Label Distribution Protocol
“OSPF” Open Shortest Path First
“IS-IS” Intermediate System-Intermediate System
“RSVP-TE” Resource Reservation Protocol-Traffic Engineering
“VPN” Virtual Private Network
“MPLS” Multi-Protocol Label Switching
“LSP” Label-Switched Path
“TCP” Transport Control Protocol
“UDP” User Datagram Protocol
“IP” Internet Protocol
“IPv4” Internet Protocol version 4
“IPv6” Internet Protocol version 6
“AS” Autonomous System
“ASes” Autonomous Systems
“DC” Data Center
“Tx” Transmit
“Rx” Receive
“ICMP” Internal Control Message Protocol
“NLRI” Network Layer Reachability Information
“VPN” Virtual Private Network
“OSI” Open Systems Interconnection”
“IETF” Internet Engineering Task Force
“RFC” Request for Comments
“NTP” Network Time Protocol
“PTP” Precision Time Protocol
“RFC” Request for Comments “PBKDF2” Password-Based Key Derivation Function 2
“PKCS” Public Key Cryptography Standards
“HMAC” Hash-Based Message Authentication Code
“SHA1” Secure Hash Algorithm 1
“AES” Advanced Encryption Standard

Embodiments described in the subject disclosure introduce the concept of using an overlay protocol embedded in a network control protocol. As described herein, various embodiments enable an efficient, generic mechanism for measuring end-to-end latency of packets in a network control protocol with precision. For example, in one embodiment, the ICMP protocol can be used as an overlay embedded in a network control protocol such as Border Gateway Protocol (BGP). ICMP packets such as echo request and echo response can be exchanged as the payloads of a BGP protocol packet. Since embedded ICMP packets share the same fate as regular BGP control protocol packets, the ICMP packets can be used to measure the various network properties, such as latency, of the BGP control protocol packets.

Various embodiments are described herein in the context of BGP as the network control protocol, however the concepts and principles of the subject disclosure can also be applied to other network control protocols such as LDP, OSPF, IS-IS and RSVP-TE to name a few. A network control protocol is sometimes also referred to as a “control plane protocol” since such protocols belong to the control plane of a node in the network.

BGP is widely used as a network control protocol to exchange routing information on the Internet, especially between autonomous systems (ASes). BGP has been extended to exchange any network layer reachability information (NLRI), such as to set-up different types of layer-3, layer-2 VPNs, MPLS LSPs, etc.

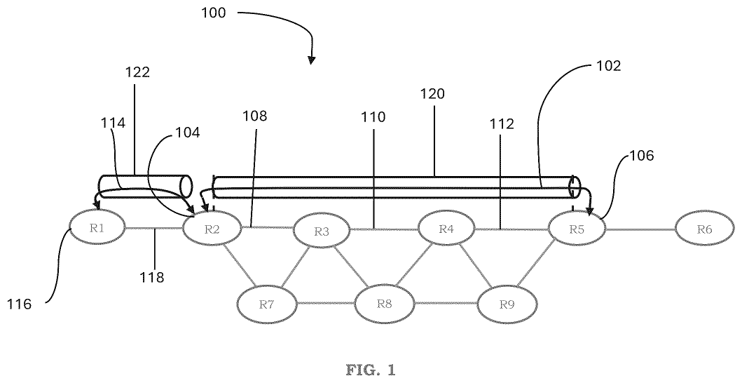

Referring now to FIG. 1, an exemplary BGP network 100 is illustrated showing several sample BGP peering sessions. BGP peering between a pair of IP network devices, such as BGP routers, is called a BGP session. A typical router comprises at least one processor and at least one memory including program code. The memory and program code with the processor are configured to cause the router to operate as described by the program code. The program code can be in the form of an algorithm which, when executed by the memory and processor, causes the router to perform the various functions of the method described by the algorithm.

Peering BGP routers can be connected directly or through multiple hops as described herein. FIG. 1 illustrates:
a first BGP peering session 102 between two routers R2 104 and R5 106, separated by multiple hops 108, 110, 112; and
a second BGP peering session 114 between routers R1 116 and R2 104 across a directly connected link 118.

A BGP session (102, 114) typically runs in the OSI “host” layers (i.e. the Application, Presentation, and Session layers) atop the OSI Transport Layer. Transport Control Protocol (TCP) is an OSI Transport Layer protocol that provides a lossless, reliable, in order delivery channel for BGP messages in a session. To create a BGP session (102, 114), first, the peering BGP routers (R2 104/R5 106, R1 116/R2 104) make a TCP connection (120, 122) by creating a TCP session on port 179. Port 179 indicates BGP as the application atop TCP. Once the TCP connection (120, 122) is operational, the peering BGP routers (R2 104/R5 106, R1 116/R2 104) establish the BGP session (102, 114) over the TCP connection (120, 122). After a BGP session (102, 114) is established, the peering routers (R2 104/R5 106, R1 116/R2 104) can exchange any reachability information (as messages) over the BGP session (102, 114). A BGP router (104, 116) sends 19-byte keep-alive messages every 60 seconds to maintain the session (102, 114).

A BGP session between two routers in the same autonomous system (AS) is referred to as Internal BGP (iBGP or Interior Border Gateway Protocol). A BGP session between routers in different autonomous systems is called External BGP (eBGP or Exterior Border Gateway Protocol). Although BGP was introduced as an exterior gateway protocol to exchange routing information among autonomous systems (ASes), it is now heavily deployed in large scale data centers (DCs) as a control plane for virtualized network overlays etc.

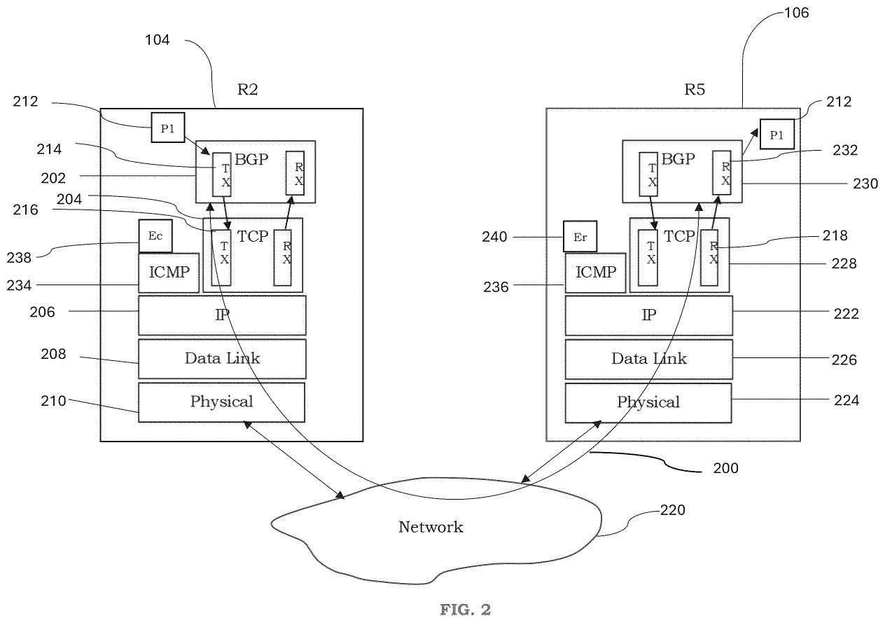

FIG. 2 illustrates an overview of how BGP packets are exchanged in a peering session 200 between routers R2 104 and R5 106. BGP 202, 230 uses TCP 204, 228 as the Transport layer protocol which, in turn, runs atop the OSI Network Layer protocol which, in the example embodiment, is Internet Protocol (IP) 206, 222. IP (IPv4 or IPv6) 206, 222 runs atop an OSI Data Link layer protocol 208, 226 such as Ethernet. The Physical layer 210, 224 provides the physical media to transport Ethernet frames. TCP is a reliable, connection oriented, byte-streaming protocol.

In the example BGP peering session 200 illustrated in FIG. 2, router (R2) 104 generates a BGP packet (P1) 212 to be sent to router (R5) 106. The exchange of packet P1 212 involves at least the following sequence:
At the beginning of the exchange timeline, router (R2) 104 may enqueue packet (P1) 212 into its BGP internal transmit queue 214. This queue may be needed if the TCP transmit queue 216 is full. The TCP transmit queue 216 may be full if router (R5) 106 reduces the TCP window size to near zero. Router (R5) 106 may do so if its TCP receiving queue 218 is full. The (R5) TCP receiving queue 218 may be full if BGP 230 in router (R5) 106 does not process packets at least as fast as router (R2) 104 sends BGP packets 212 to router (R5) 106. (It should be noted that the transmit and receive queue pair in both BGP and TCP stacks are per peering session.)
After a delay/latency of L-bgp-tx, packet (P1) 212 is dequeued from the BGP transmit queue 214 and inserted into the TCP transmit queue 216.
After a delay/latency of L-tcp-tx, packet (P1) 212 is dispatched by router (R2) TCP 204 to router (R2) IP 206.
Eventually, the packet (P1) 212 is transmitted from router (R2) 104 to router (R5) 106 via the network 220. The packet (P1) 212 travels through the network 220, arrives at (R5) IP 222, and is enqueued at router (R5) TCP receive queue 218 after a delay/latency L-ip-tx
After a delay/latency of L-tcp-rx, packet (P1) 212 is dequeued from TCP receiving queue 218 by BGP 230 in router (R5) 106. BGP 230 may further enqueue the packet (P1) 212 to router (R5) BGP receiving queue 232.
After a delay/latency of L-bgp-rx, packet (P1) 212 is finally processed by BGP 230 in router (R5) 106.

In this example, the total delay/latency for packet (P1) 212 in the exchange (Lp1−total) is: Lp1−total=L-bgp-tx+L-tcp-tx+L-ip-tx+L-tcp-rx+L-bgp-rx

The Internet Control Message Protocol (ICMP) may be used to test IP connectivity among two routing nodes. ICMP 234, 236 usually runs atop the IP 206, 222 (the OSI Network layer protocol), as shown in FIG. 2. Referring to FIG. 2, ICMP echo request and echo reply messages can be used to test connectivity and network latency between router (R2) 104 and router (R5) 106. For example, router (R2) 104 can send an ICMP echo request message (Ec) 238 to router (R5) 106. A timestamp (T1) can be encoded at router (R2) 104 recording the time ICMP echo request message (Ec) 238 is dispatched. When router (R5) 106 receives the ICMP echo request message (Ec) 238, router (R5) 106 sends an ICMP echo reply message (Er) 240 back to router (R2) 104. When router (R2) ICMP 234 receives and processes the ICMP echo reply message (Er) 240 at time (T3), it can calculate the round-trip network latency as the difference between T3 and T1 and the one-way network latency as (T3−T1)/2.

However, because ICMP 234, 236 runs atop the OSI Network layer (IP 206, 222), the calculated one-way network latency only accounts for L-ip-tx and not the TCP (L-tcp-tx+L-tcp-tx) and BGP (L-bgp-rx+L-bgp-rx) portions of the total latency for BGP packet (P1) 212. As described above, when TCP slow peering problems arise, such as when router (R5) 106 causes backpressure on transmission of BGP packets from router (R2) 104, the BGP and TCP (“host” layer) portions of the total latency may significantly affect the total latency. The same deficiency can apply to other network control protocols, such as LDP, OSPF, IS-IS, RSVP-TE, etc. As such, a generic solution that can measure the total, end-to-end latency of any network control protocol could be useful.

Example embodiments described herein introduce the concept of embedding an overlay protocol in the network control protocol such that packets of the embedded overlay protocol follow the same path and suffer the same fate as the control protocol packets of the network control protocol. As such, by embedding ICMP as the overlay protocol and using the ICMP echo request and echo replay messages of the embedded ICMP overlay protocol, it is possible to measure the total, end-to-end latency of network control protocol packets with precision. Furthermore, this concept can be applied to almost any network control protocol, making it a generic mechanism to measure the total, end-to-end latency of almost any network control protocol.

For example, using the BGP peering session described above with respect to FIG. 2, instead of using the ICMP protocol 234, 236 running atop the IP layer 208, 222, a version of the ICMP protocol can be embedded in the network control protocol BGP as an overlay protocol. In this example, ICMP packets, such as the echo request and echo response, can be exchanged as payloads of a BGP packet. As such, the BGP packets carry the embedded ICMP packets and are exchanged between routers (R2) 104 and (R5) 106 in the same manner as regular BGP control protocol packets. Using the ICMP features described above with respect to FIG. 2, latency measurements based on the embedded ICMP packets will account for the BGP and TCP (“host”) portions of the total, end-to-end latency of BGP control protocol packets. In this way, it becomes possible to easily and accurately measure the total, end-to-end latency of BGP packets. Alternatively, the ICMP protocol can be embedded into other network control protocols such as LDP, OSPF, IS-IS, RSVP-TE, to name a few, to easily and accurately measure the total, end-to-end latency of any of these other network control protocols, making it a generic mechanism for measuring the total, end-to-end latency of almost any network control protocol.

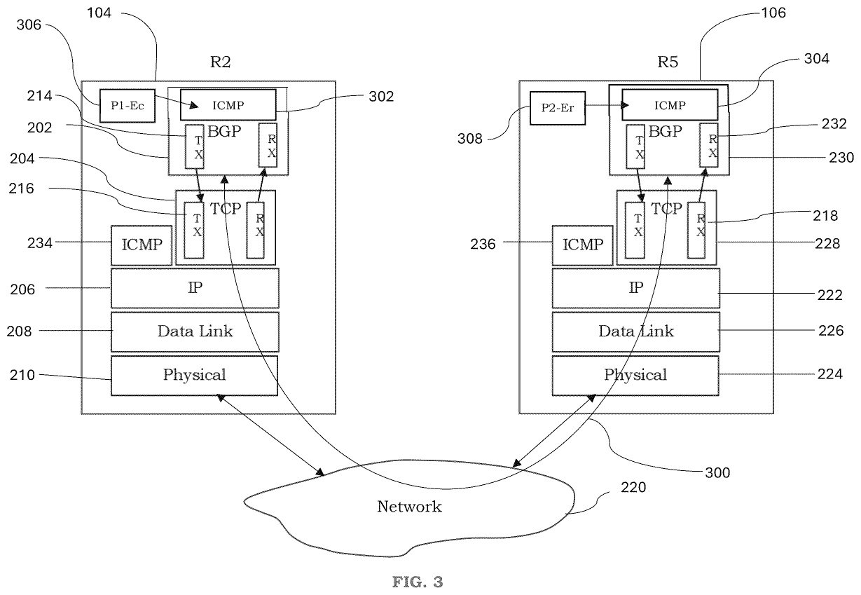

Referring now to FIG. 3, another example of a BGP peering session 300 between routers (R2) 104 and (R5) 106 is illustrated. Like the BGP peering session 200 shown in FIG. 2, BGP 202, 230 in peering session 300 uses TCP 204, 228 as the Transport layer protocol which, in turn, runs atop the IP layer (IPv4 or IPv6) 206, 222. IP 206, 222 runs atop Data Link layers 208, 226 such as Ethernet. Physical layers 210, 224 provides the physical media to transport Ethernet frames. However, in this example, BGP peering session 300 is configured to calculate the total, end-to-end latency according to an example embodiment.

In BGP peering session 300, the BGP protocol 202, 230 of each, router (R2) 104 and (R5) 106, includes an embedded instance of the ICMP protocol 302, 304. In this embodiment, an embedded ICMP packet is sent and received as payload of a BGP packet such that the embedded ICMP packet travels across the same route and experiences the same delays/latencies as any other BGP packet exchanged between routers (R2) 104 and (R5) 106. Various embodiments can use BGP-ICMP-echo (P1-Ec) 306 to denote the ICMP echo request message embedded inside a BGP packet and BGP-ICMP-echo-reply (P2-Er) 308 to denote the ICMP echo reply message embedded inside a BGP packet. Following a sequence similar to the one shown in FIG. 2 for the exchange of a BGP packet between routers (R2) 104 and (R5) 106, router (R2) generates a BGP-ICMP-echo request message (P1-Ec) 306 to router (R5) 106. The exchange of BGP-ICMP-echo request message (P1-Ec) 306 involves at the following sequence:
At the beginning of the exchange timeline, router (R2) 104 may enqueue BGP-ICMP-echo request message (P1-Ec) 306 into its BGP internal transmit queue 214.
After a delay/latency of L-bgp-tx, BGP-ICMP-echo request message (P1-Ec) 306 is dequeued from the BGP transmit queue 214 and inserted into the TCP transmit queue 216.
After a delay/latency of L-tcp-tx, BGP-ICMP-echo request message (P1-Ec) 306 is dispatched by router (R2) TCP 204 with the embedded BGP-ICMP-echo request message (P1-Ec) 306 configured as an IP packet.
The IP packet, including the embedded BGP-ICMP-echo request message (P1-Ec) 306, is transmitted from router (R2) 104 to router (R5) 106 via the network 220. Eventually, the BGP-ICMP-echo request message (P1-Ec) 306 reaches the (R5) IP layer 222. The total propagation delay of the IP packet from router (R2) 104 to router (R5) 106 is L-ip-tx. Upon reaching the (R5) IP layer 222, the BGP-ICMP-echo request message (P1-Ec) 306 is enqueued to the (R5) TCP receive queue 218.
After a delay/latency of L-tcp-rx, the BGP-ICMP-echo request message (P1-Ec) 306 is dequeued from TCP receiving queue 218 by router (R5) BGP 230. BGP 230 may further enqueue BGP-ICMP-echo request message (P1-Ec) 306 to the (R5) internal BGP receiving queue 232.
After a delay/latency of L-bgp-rx, BGP-ICMP-echo request message (P1-Ec) 306 is processed by router (R5) BGP protocol 230. While processing the BGP-ICMP-echo request message (P1-Ec) 306, BGP 230 finds that the payload of the BGP-ICMP-echo request message (P1-Ec) 306 is an ICMP echo request message, so the BGP 230 hands over the payload ICMP echo request message to the instance of the ICMP protocol 304 embedded in BGP 230 at time T2.

In this exchange, the total delay/latency for the BGP-ICMP-echo request message (P1-Ec) 306 (L-P1-Ec−total) is: L-P1-Ec−total=L-bgp-tx+L-tcp-tx+L-ip-tx+L-tcp-rx+L-bgp-rx, which is the same as L-bgp (i.e. the latency of any other BGP packet sent from R2 to R5).

Continuing the exchange, (R5) embedded ICMP instance 304, generates a BGP-ICMP-echo-reply message (P2-Er) 308 in response to the received BGP-ICMP-echo request message (P1-Ec) 306. BGP-ICMP-echo-reply message (P2-Er) 308 is an ICMP echo reply message embedded as the payload inside a BGP packet P2. The BGP-ICMP-echo-reply message (P2-Er) 308 is dispatched to router (R2) 104 in the reverse manner as BGP-ICMP-echo request message (P1-Ec) 306 was transmitted from router (R2) 104 to router (R5) 106.

Eventually, (R2) BGP 202 receives and processes the BGP-ICMP-echo-reply message (P2-Er) 308. While processing the BGP-ICMP-echo-reply message (P2-Er) 308, (R2) BGP 202 finds that the message payload is an ICMP echo reply packet, so it hands over the payload to the embedded instance of the ICMP protocol 302 at time T3. The embedded ICMP protocol instance 302 can then compute a round trip BGP peering latency (RTLbgp) as the difference between T3 and T1. The approximate latency of a BGP packet from router (R2) 104 to router (R5) 106 can be calculated as: L-bgp=(T3−T1)/2 which is nearly the same as the one-way latency of a BGP packet from router (R2) 104 to router (R5) 106.

In another example embodiment, (R5) embedded ICMP protocol instance 304 may be enhanced to encode the timestamp (T2) of receipt of the BGP-ICMP-echo request message (P1-Ec) 306 by router (R5) 106 into the BGP-ICMP-echo-reply message (P2-Er) 308. In this embodiment, both router (R2) 104 and router (R5) 106 should be time synchronized, possibly using time synchronization protocols such as Network Time Protocol (NTP), Precision Time Protocol (PTP)/, and the like, in order for timestamp (T2) to be most useful for accurately calculating the one-way latency of a BGP packet sent from router (R2) 104 to router (R5) 106. However, even without routers (R2) 104 and (R5) 106 being time synchronized, the approximate latency calculated by dividing the round-trip latency of a BGP packet (RTLbgp=T3−T1) from router (R2) 104 to router (R5) 106 by 2 is usually a very accurate approximation of the one-way latency of a BGP packet sent from router (R2) 104 to router (R5) 106.

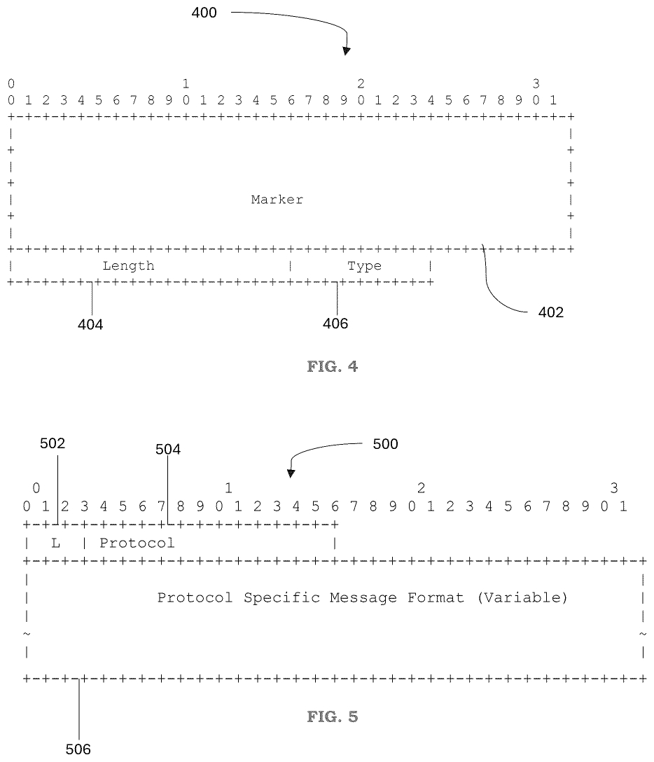

FIGS. 4-8 illustrate various embodiments of embedding an overlay protocol message inside of a BGP packet. As shown in FIG. 4, a BGP message has a fixed-size header 400.

There may or may not be a data portion following the header, depending on the message type. The various fields of the header 400 can include a Marker field 402, a Length field 404, and a Type field 406. The Marker field 402 can be a 16-octet field included for compatibility and it is usually set to all ones. The Length field 404 can be a 2-octet unsigned integer indicating the total length of the message, including the header, in octets and it can be used to locate the Marker field of the next message in the TCP stream. The value of the Length field 404 should be at least 19 and usually no greater than 4096 and may be constrained depending on the message type. “Padding” of extra data after the message is usually not allowed, therefore, the Length field 404 usually has the smallest value required, given the rest of the message. The Type field 406 can be a 1-octet unsigned integer indicating a type code for the message. Conventionally, BGP messages fall into one of 5 different message types:
1. OPEN
2. UPDATE
3. NOTIFICATION
4. KEEPALIVE
5. ROUTE-REFRESH

The remaining values in the Type field 406 are reserved for new message types. Example embodiments propose introducing a new BGP message type, termed “OVERLAY_PROTOCOL.” This new message type can be assigned one of the values reserved for new message types. For the purposes of this disclosure, we'll assign the “OVERLAY_PROTOCOL” message type value 6, but it is easily understood by a person skilled in the art that any available message type value could be assigned to this new message type. Message type “OVERLAY_PROTOCOL” indicates that the payload of the message (i.e. the data following the fixed header) includes messages for another protocol.

One example embodiment of the format of an “OVERLAY_PROTOCOL” message that can be sent as the payload following the fixed-sized BGP header 400 is illustrated in FIG. 5. As shown in FIG. 5, this embodiment of an “OVERLAY_PROTOCOL” message 500 includes a Layer field (L) 502, a Protocol field 504, and a Protocol Specific Message Format field 506.

The Layer field (L) 502 can be 3-bits and can indicate the level at which the embedded overlay protocol traditionally operates. For example, in the embodiment illustrated in FIG. 5, the Layer field (L) 502 could be set to “0” to indicate that the embedded protocol is a standard protocol that traditionally operates atop the OSI Data Link layer (such as Ethernet) or it could be set to “1” to indicate that the embedded overlay protocol is a standard protocol that traditionally operates atop the OSI Network layer. The Protocol field 504 can be variable in length and can be configured to encode a value indicative of the protocol type that is embedded in the message 500. The Protocol Specific Message Format field 506 can be variable in length and can be used to provide protocol specific information which would depend on the value encoded in the Protocol field 504.

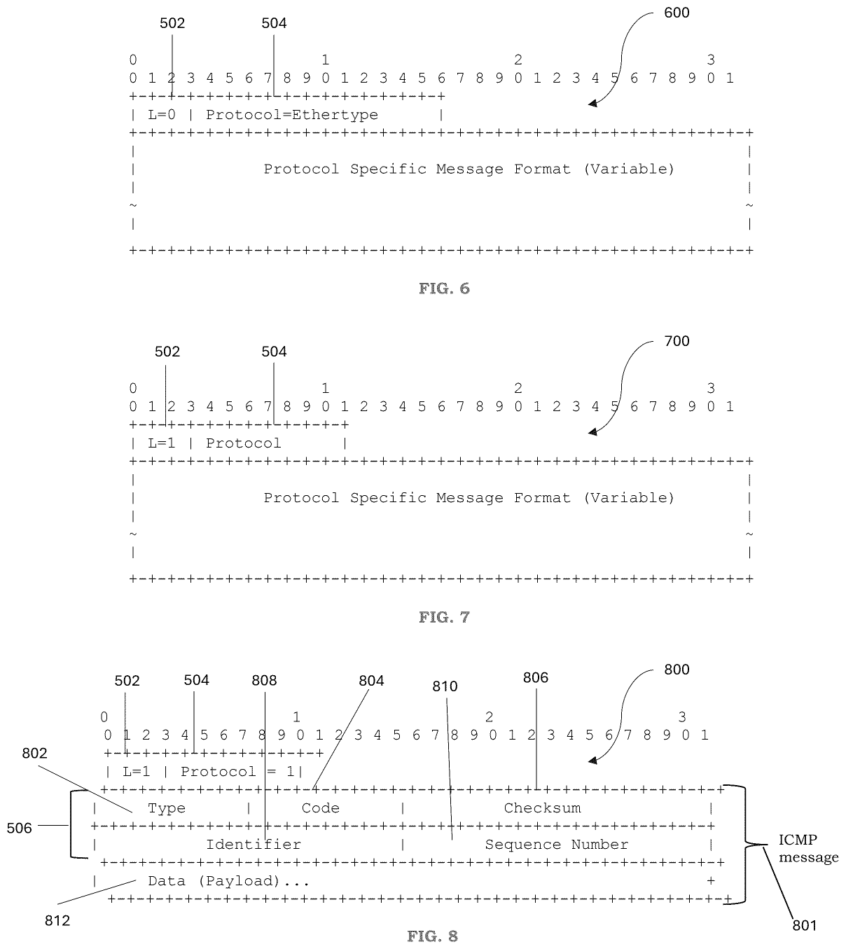

FIG. 6 is an example embodiment of an “OVERLAY_PROTOCOL” message 600 with the Layer field (L) 502 value set to “0” to indicate that the embedded overlay protocol is traditionally run atop the OSI Data Link layer such as Ethernet. In this embodiment, the Protocol field 504 is a 16-bit field that encodes a standard Ethertype value. For example, the Protocol field 504 can be set to 0x0800 to indicate that the messages are IPv4 packets or set to 0x86dd to indicate that the messages are IPv6 packets.

FIG. 7 is an example embodiment of an “OVERLAY PROTOCOL” message 700 with the Layer field (L) 502 value set to “1” to indicate that the embedded protocol is traditionally run atop the OSI Network level. In this embodiment, the Protocol field 504 is an 8-bit field that encodes a protocol ID indicative of the specific embedded overlay IP level protocol. For example, the Protocol field 504 can be set to “1” to indicate that the messages are ICMP packets, set to “6” to indicate that the messages are TCP packets, or set to 17 to indicate that the messages are UDP packets.

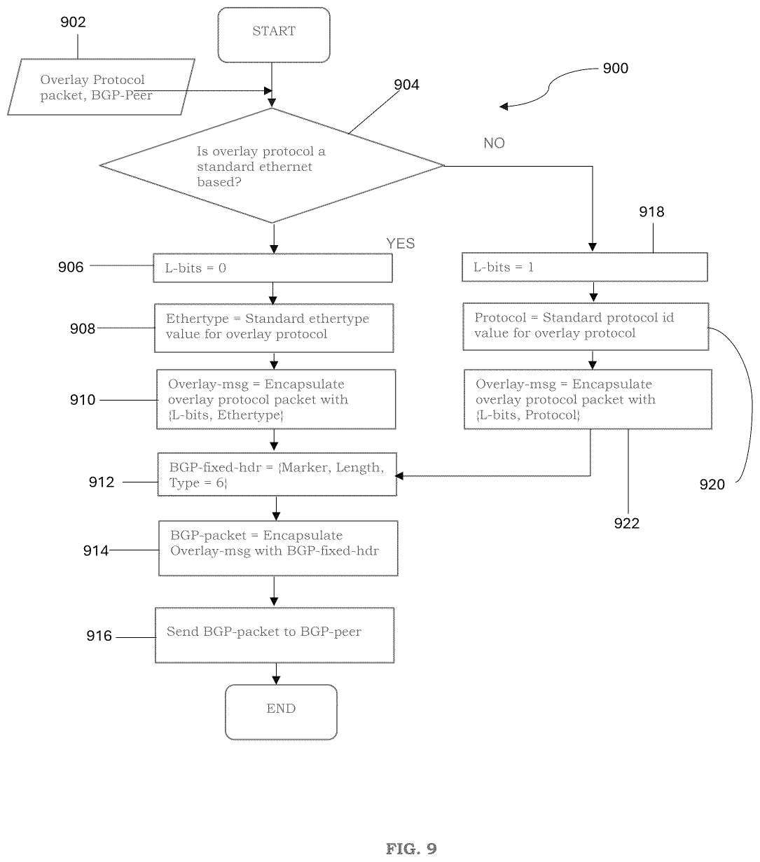

In one example embodiment, the embedded overlay protocol can be set to ICMP and the ICMP echo request and echo reply messages can be used for measuring the end-to-end latency of the network. FIG. 8 is one example embodiment of an ICMP “OVERLAY_PROTOCOL” message 800 in which an ICMP message/packet 801 is embedded as the payload of a BGP packet. As illustrated in FIG. 8, the Layer field (L) 502 value is set to “1” to indicate that the embedded overlay protocol, ICMP in this case, is traditionally run atop the OSI Network layer (in this example the OSI Network layer protocol being Internet Protocol) and the Protocol field 504 is set to “1” to indicate that the messages are ICMP packets. In this embodiment, the Protocol Specific Message Format field 506 includes 5 fields containing information specific to ICMP messages. The “Type” field 802 is an 8-bit field that indicates the type of ICMP message being sent. It provides a brief description of the message so that the receiving network device knows what kind of message it is receiving and how to respond to it. It can be set to “8” for an ICMP echo request message for IPv4 or “128” for an ICMP echo request message for IPv6. The “Type” field 802 can be set to “0” for an ICMP echo reply message for IPv4 or “129” for an ICMP echo reply message for IPv6. Several other common ICMP message types are:
“3”—Destination unreachable
“5”—Redirect Message
“11”—Time Exceeded
“12”—Parameter problem
“13”—Timestamp Message
“14”—Timestamp Reply Message
   The “Code” field 804 is an 8-bit field that carries some additional information about the error message and type. In the example embodiment shown in FIG. 8, the “Code” field 804 is set to “0” for both ICMP echo request and echo reply type messages. The next field is a 16-bit “Checksum” field 806. The “Checksum” field 806 is the 16 bit one's complement of the one's complement sum of the ICMP message starting with the ICMP “Type” field 802. For computing the checksum, the “Checksum” field 806 should be zero. If the total length is odd, the received data is padded with one octet of zeros for computing the checksum. This checksum may be replaced in the future. The “Identifier” and “Sequence Number” fields 808, 810 comprise the rest of the ICMP header. Together, they form a 4-byte field the contents of which varies based on the ICMP “Type” 802 and “Code” 804. In the example embodiment shown in FIG. 8, since the ICMP “Type” field 802 is set to either “8” or “128” or an echo request message or “0” or “129” for an echo reply message and the “Code” field is set to “0”, both the “Identifier” field 808 and the “Sequence Number” field 810 include an identifier to aid in matching ICMP echo requests and ICMP echo replies. Finally, following the fields comprising the Protocol Specific Message Format field 506, any ICMP data specific to the ICMP message type can be transmitted in the payload “Data” field 812. In a similar manner, ICMP or other overlay protocol messages may be embedded with other network control protocols such as LDP, OSPF, IS-IS, RSVP-TE, to name a few.

A standard tool that implements ICMP echo request and echo reply messaging to measure the round-trip time (RTT) latency in an IP network is Packet Inter-Network Groper “ping”. The ping tool is typically executed from the command line of a router as shown below:
Router #Ping 135.227.208.147
PING 135.227.208.147 (135.227.208.147) 56(84) bytes of data.
64 bytes from 135.227.208.147; icmp_seq=1 ttl=64 time=0.021 ms
64 bytes from 135.227.208.147; icmp_seq=2 ttl=64 time=0.020 ms
64 bytes from 135.227.208.147; icmp_seq=3 ttl=64 time=0.018 ms
. . . / . . . /
- - - 135.227.208.147 ping statistics - - -
3 packets transmitted, 3 received. 0% pack loss, time 2072 ms
rtt min/ave/max/mdev=0.018/0.019/0.021/0.001 ms

In this example, 135.277.208.147 is the IPv4 address of a destination router in the IP network which corresponds to router (R5) 106 in FIG. 1. When an instance of ICMP is embedded as the payload inside a BGP message, such as in the example embodiment described above, the ping utility runs inside BGP and the BGP-ICMP-echo and BGP-ICMP-echo-reply can be implemented as shown below:
router #enter bgp
router->bgp #ping 135.227.208.170
PING 135.227.208.170 (135.227.208.170) 56(84) bytes of data.
64 bytes from 135.227.208.170; icmp_seq=1 ttl=64 time=0.053 ms
64 bytes from 135.227.208.170; icmp_seq=2 ttl=64 time=0.057 ms
64 bytes from 135.227.208.170; icmp_seq=3 ttl=64 time=0.051 ms
64 bytes from 135.227.208.170; icmp_seq=4 ttl=64 time=0.052 ms
64 bytes from 135.227.208.170; icmp_seq=5 ttl=64 time=0.050 ms
64 bytes from 135.227.208.170; icmp_seq=6 ttl=64 time=0.052 ms
64 bytes from 135.227.208.170; icmp_seq=7 ttl=64 time=0.048 ms
- - - 135.227.208.170 ping statistics - - -
7 packets transmitted, 7 received. 0% pack loss, time 6171 ms
rtt min/ave/max/mdev=0.048/0.051/0.057/0.009 ms
   In this example, 135.227.208.170 is an IPv4 loopback address of a destination BGP peer instance. For example, it could be the address of a BGP peer instance in router (R5) 106 and in that case the command is executed in the BGP instance of router (R2) 104.

In addition to the example embodiment described above, other tools and/or other embedded overlay protocols can be used to perform network latency measurements and/or other network administration tasks. For example, the ICMP timestamp and timestamp reply messages can be used to measure latency if the source and destination routers are time synchronized. Alternatively, OWAMP and/or TWAMP could be used as the embedded overlay protocol to measure network latency with an OWAMP-Test message or a TWAMP-Test message embedded as the payload in a BGP message. These, as well as numerous other, embedded overlay protocols and network management tools can be implemented as various example embodiments using the inventive concepts disclosed herein.

Turning now to FIG. 9, an example embodiment of a method implemented by BGP to transmit an overlay protocol packet 900 is illustrated. Inputs to the method include an overlay protocol packet and the BGP peer to which the packet is to be sent 902. At step 904, a check is performed to determine whether or not the overlay protocol to be embedded is a standard ethernet based protocol (e.g. IPv4, IPv6, and the like) that runs atop the Data Link layer.

If it is, the Layer field (L) 502 in the message header is encoded with a value of “0” (Step 906) which is indicative of an embedded overlay protocol operating atop the Data Link layer. As described above, when the embedded overlay protocol operates atop the Data Link layer, the Protocol field 504 is 16-bits in length and is encoded with the Ethertype value. As such, the next step (Step 908) is to determine the standard Ethertype value of the embedded overlay protocol. Again, as described above, two possible standard Ethertype values that can be encoded into the Protocol field 504 are: 0x0800 to indicate that the overlay protocol packet is an IPv4 packet or 0X86dd to indicate that the overlay protocol packet is an IPv6 packet. Once the Ethertype value has been determined, the embedded overlay protocol packet is encapsulated with the BGP overlay message header (Step 910) which includes the encoded layer field (L) 502, which is “0” in this case, and the Protocol field 504 which, in this case is encoded with the Ethertype value.

After that, the BGP message fixed-size header, including the Marker 402, Length 404, and Type 406 fields is assembled in Step 912. As described with regards to FIG. 4, the Marker field 402 is a 16-octet field that is set to all ones. The Length field 404 is a 2-octet unsigned integer indicating the total length of the message, including the header and the Type field 406 is a 1-octet unsigned integer indicating the type code of the message. In the embodiment described above, the embedded overlay protocol message is a new type of message, so the Type field 406 was assigned one of the type field values reserved for new message types, in this case “6”.

Once the BGP message fixed-size header is assembled, the BGP overlay message is encapsulated with the assembled BGP fixed-size header in step 914 to form a completed BGP embedded overlay packet and the completed BGP overlay packet is sent to the intended BGP peer in step 916.

If it is determined, in Step 904, that the overlay protocol to be embedded is not a standard ethernet based protocol, it is assumed that the overlay protocol to be embedded is a standard protocol that traditionally operates atop the IP layer. In this case, the Layer field (L) 502 in the message header is encoded with a value of “1” (Step 918) which is indicative of an embedded overlay protocol operating atop the IP layer. As described above, when the embedded overlay protocol operates atop the IP layer, the Protocol field 504 is 8-bits in length and is encoded with the standard protocol ID value. As such, the next step (Step 920) is to determine the standard protocol ID value of the embedded overlay protocol. Again, as described above, three well known protocol ID values that can be encoded into the Protocol field 504 are: “1” to indicate that the embedded overlay protocol packet is an ICMP packet, “6” to indicate that the embedded overlay protocol packet is a TCP packet, or “17” to indicate that the embedded overlay protocol packet is an UDP packet. In the embodiment described above in which an ICMP echo request message is being used to determine the overall, end-to-end latency of a BGP packet, the Protocol field 504 will be set to a value of “1” to indicate that the embedded overlay protocol is ICMP. The embedded overlay protocol packet inputted in step 902 will include the remaining fields of the ICMP echo request message in which the “Type” field 802 will be set to “8” to indicate that the ICMP message is an ICMP echo request message, the “Code” field 804 will be set to “0”, the “Checksum” field 806 will be set to the 16-bit one's complement of the one's complement sum of the ICMP message, the “Identifier” field 808 will be set to “0”, and the “Sequence Number” field 810 will be set to “0”. The embedded overlay protocol packet is then encapsulated with the BGP overlay message header (Step 922) which includes the encoded Layer field (L) 502, which is “1” in this case, and Protocol field 504, which is “1” in this case.

After that, the BGP message fixed-size header is assembled in Step 912 with the Type field 406 encoded with a type number reserved for new types of messages, such as “6” in the example embodiment to indicate that this is an embedded overlay protocol message, the BGP overlay message is encapsulated with the assembled BGP fixed-size header in step 914 to form a completed BGP overlay packet, and the completed BGP overlay packet is sent to the intended BGP peer in step 916.

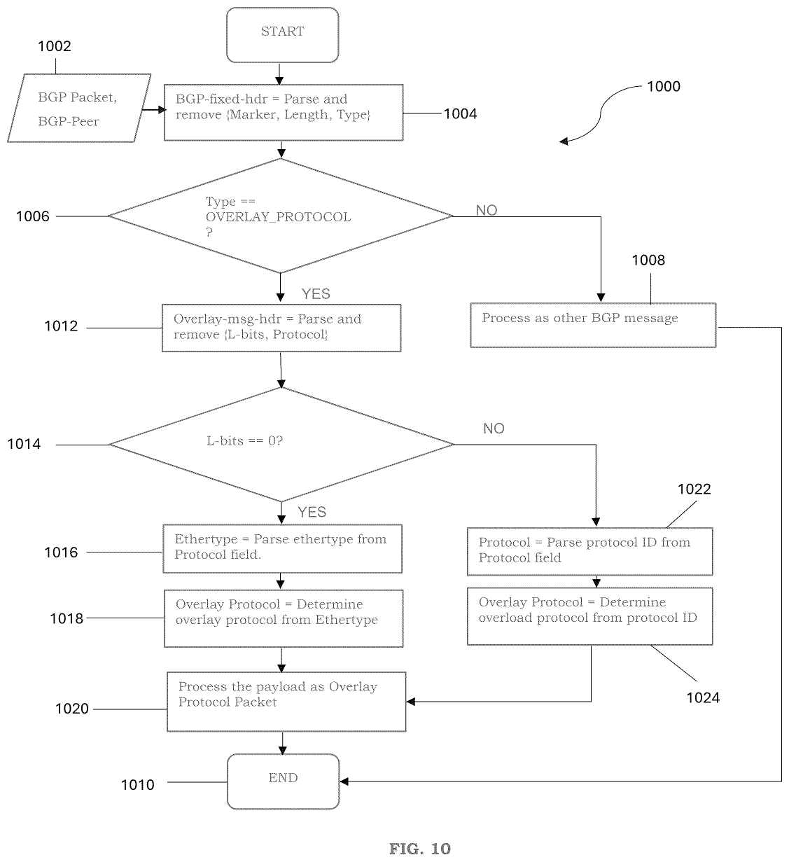

Turning now to FIG. 10, a method for processing an overlay protocol embedded in a BGP message 1000 is illustrated. Inputs to the method include the BGP message with embedded overlay protocol and the identity of the BGP peer that sent the BGP message 1002. Upon receiving the BGP message, it is parsed and the BGP fixed header is removed in step 1004. At step 1006, it is determined whether or not the BGP message is an embedded overlay protocol message by checking the Type field 406 of the BGP fixed header. If it is determined that the BGP message is not an embedded overlay protocol message, the BGP message is processed like any other BGP message in step 1008 and the method terminates in step 1010.

If it is determined that the BGP message is an embedded overlay protocol message (in the embodiment described herein the Type field 406 is “6”), the BGP overlay message header is parsed and removed in step 1012. Next, in step 1014, the method evaluates the BGP overlay message header Layer field (L) 502 to determine whether or not the embedded overlay protocol traditionally runs atop the Data Link layer or the IP layer.

If the Layer field (L) 502 is “0”, that is indicative of an embedded overlay protocol that traditionally runs atop the Data Link layer so the method parses the BGP overlay message header Protocol field 504 in step 1016 identifying the 16-bit Ethertype value encoded in the Protocol field 504 and determines the embedded overlay protocol (IPv4, IPv6, etc.) from the Ethertype value in step 1018. Finally, the method processes the message payload as the determined embedded overlay protocol packet in step 1020 and the method terminates in step 1010.

If the Layer field (L) 502 is “1”, that is indicative of an embedded overlay protocol that traditionally runs atop the IP layer so the method parses the BGP overlay message header Protocol field 504 as an 8-bit protocol ID value in step 1022. Next, the method determines the embedded overlay protocol based on the 8-bit protocol ID value in step 1024. In the embodiment described herein used for determining the overall, end-to-end latency of a BGP packet, the protocol ID value is “1” indicating that the embedded overlay protocol is ICMP. Next, the message payload is processed as an ICMP message 801 in step 1020. In doing so, the method will parse the ICMP message “Type” field 802 to determine the type of embedded overlay protocol message. In the embodiment described herein, the ICMP “Type” field 802 will be an “8”, which is indicative of an ICMP echo request message. The method will then process the BGP packet as an ICMP echo request message (step 1020) and terminate in step 1010.

Referring back to FIGS. 3, 9 and 10, we apply the described methods for sending and processing an embedded overlay protocol BGP message to determine the overall, end-to-end latency of a BGP packet. The overlay ICMP packet 801 and the BGP peer to which the packet is to be sent (router (R5) 106) are provided as input to the originating BGP peer, router (R2) 104, in step 902. The input ICMP Message 801 includes a Type field 802 encoded with an “8” and a Code field 804 encoded with a “0” to indicate that the input ICMP message 801 is an echo request message. The Checksum field 806 is encoded with the 16-bit one's complement of the one's complement sum of the input ICMP message 801 starting with the Type field 502. The Identifier field 808 and Sequence Number field 810 are both 16-bit fields sometimes shown divided into a Big Endian (BE) value and a Little Endian (LE) value. These fields 808, 810 are encoded with values used to link an echo request packet (from router (R2) 104) to an echo reply packet (from router (R5) 106). For the purposes of the illustrated embodiment, the input Identifier field 808 and Sequence Number field 810 are encoded with the following:
Identifier (BE): 20731 (0x50ffb)
Identifier (LE): 64336 (0xfb50)
Sequence Number (BE): 0 (0x0000)
Sequence Number (LE): 0 (0x0000)

During step 904, it is determined that the input embedded overlay protocol packet is ICMP which traditionally runs atop the IP layer so the process of building the BGP overlay message header for an embedded overlay protocol that is not a standard ethernet based protocol begins. In step 918, the Layer field (L) 502 in the BGP overlay message header is set to a value of “1” to indicate that the input embedded overlay protocol packet is not a standard ethernet based protocol and in step 920, the Protocol field 504 in the BGP overlay message header is set to a value of “1” to indicate that the embedded overlay protocol is ICMP. Once the Layer field (L) 502 and Protocol field 504 have been encoded, the ICMP message 801 is encapsulated in the BGP overlay message header in step 922 to form the ICMP “OVERLAY_PROTOCOL” message 800.

After that, the BGP message fixed-size header 400, including the Marker 402, Length 404, and Type 406 fields is assembled in Step 912. As previously described, the Marker field 402 is set to all ones, the Length field 404 is set to reflect the total length of the message, including the header, and the Type field 406 is encoded with a type number reserved for new types of messages, such as “6” in the embodiment described herein, to indicate that the payload of the BGP message includes a message for another protocol (i.e. it isn't one of the original 5 BGP message types, instead it is a “new” message type). Once the BGP message fixed-size header 400 is assembled, the ICMP “OVERLAY_PROTOCOL” message 800 is encapsulated with the assembled BGP fixed-size header 400 in step 914 to form a completed BGP-ICMP-echo request message (P1-Ec) 306.

The completed BGP-ICMP echo request message (P1-Ec) 306 is sent from router (R2) 104 to the router (R5) 106 in step 916. At the same time, a timestamp (T1) is encoded at router (R2) 104 recording the time the BGP-ICMP echo request message (P1-Ec) 306 is dispatched. The BGP-ICMP echo request message (P1-Ec) 306 travels through the network 220 until it reaches its destination, router (R5) 106. Once the BGP-ICMP echo request message (P1-Ec) 306 reaches router (R5) 106, it is processed as follows.

The BGP-ICMP echo request message (P1-Ec) 306 and identity of the sending BGP peer, router (R2) 104, are delivered as inputs to router (R5) 106 in step 1002. Upon receiving the BGP-ICMP echo request message (P1-Ec) 306, router (R5) 106 parses it and removes the BGP fixed size header 400 in step 1004. By examining the Type field 406 of the BGP fixed sized header 400, which is encoded with the value “6”, it is determined that the BGP-ICMP echo request message (P1-Ec) 306 is of the type OVERLAY_PROTOCOL so processing moves on to step 1012. In step 1012, the BGP overlay message header, including the Layer field (L) 502 and Protocol field 504, is parsed and removed. Next, in step 1014, it is determined that the value “1” is encoded in the Layer field (L) 502, signifying that the embedded overlay protocol traditionally runs atop the IP layer, so processing moves on to step 1022. In step 1022, by parsing the Protocol field 504, it is determined that the Protocol field 504 is encoded with the value “1”. In step 1024, it is determined that the value “1” encoded in the Protocol field 504 signifies that the embedded overlay protocol is ICMP.

In step 1020, the remaining portion of the message, the ICMP packet 801, is processed as an ICMP message. As part of that processing, the Type field 802, which is encoded with the value “8”, and the Code field 804, which is encoded with the value “0”, are parsed and, based on their encoded values, the router (R5) 106 determines that the ICMP packet 801 is an ICMP echo request message. In another embodiment, upon determining that the ICMP packet 801 is an ICMP echo request message, a timestamp (T2) is encoded at router (R5) 106 recording the time the BGP-ICMP echo request message (P1-Ec) 306 is processed. This timestamp (T2) can be sent back to router (R2) 104 so that router (R2) 104 can determine the overall, end-to-end latency of a BGP packet as the difference between T2 and T1. However, in the embodiment currently being described, router (R5) 106 instead begins the process of responding with an ICMP echo reply message embedded as the payload in a BGP message.

The process of responding to the ICMP echo request message from router (R2) 104 begins by supplying an embedded overlay protocol packet (ICMP Message 801 in the form of an ICMP echo reply message) and the BGP peer to which the packet is to be sent (router (R2) 104) as input to router (R5) 106 in step 902. The input ICMP Message 801 includes a Type field 802 encoded with a “0” and a Code field 804 encoded with a “0” to indicate that the input ICMP message 801 is an ICMP echo reply message. The Checksum field 806 is encoded with the 16-bit one's complement of the one's complement sum of the input ICMP message 801 starting with the Type field 502. The Identifier field 808 and Sequence Number field 810 are both encoded with values used to link the echo reply packet to the echo request packet received from router (R2) 104. In order to do so, the input Identifier field 808 and Sequence Number field 810 are encoded with the same values as those encoded in the echo request message received from router (R2) 104, namely:
Identifier (BE): 20731 (0x50ffb)
Identifier (LE): 64336 (0xfb50)
Sequence Number (BE): 0 (0x0000)
Sequence Number (LE): 0 (0x0000)

During step 904, it is determined that the input embedded overlay protocol packet is ICMP which traditionally runs atop the IP layer so the process of building the BGP overlay message header for an embedded overlay protocol that is not a standard ethernet based protocol begins. In step 918, the Layer field (L) 502 in the BGP overlay message header is set to a value of “1” to indicate that the input embedded overlay protocol packet is not a standard ethernet based protocol and in step 920, the Protocol field 504 in the BGP overlay message header is set to a value of “1” to indicate that the embedded overlay protocol is ICMP. Once the Layer field (L) 502 and Protocol field 504 have been encoded, the ICMP message 801 is encapsulated in the BGP overlay message header in step 922 to form the ICMP “OVERLAY_PROTOCOL” message 800.

After that, the BGP message fixed-size header 400, including the Marker 402, Length 404, and Type 406 fields are assembled in step 912. As previously described, the Marker field 402 is set to all ones, the Length field 404 is set to reflect the total length of the message, including the header, and the Type field 406 is encoded with a type number reserved for new types of messages, such as “6” in the embodiment described herein, to indicate that the payload of the BGP message includes a message for another protocol (i.e. it isn't one of the original 5 BGP message types, instead it is a “new” message type). Once the BGP message fixed-size header 400 is assembled, the ICMP “OVERLAY_PROTOCOL” message 800 is encapsulated with the assembled BGP fixed-size header 400 in step 914 to form a completed BGP-ICMP-echo reply message (P2-Er) 308. The completed BGP-ICMP echo reply message (P2-Er) 308 is sent from router (R5) 106 to the router (R2) 104 in step 916.

The completed BGP-ICMP echo reply message (P2-Er) 308 travels across the network 220 until it reaches router (R2) 104. Upon receiving the BGP-ICMP echo reply message (P2-Er) 308, router (R2) 104 begins processing the message as follows.

The BGP-ICMP echo reply message (P2-Er) 308 and identity of the sending BGP peer, router (R5) 106, are delivered as inputs to receiving router (R2) 104 in step 1002. Upon receiving the BGP-ICMP echo reply message (P2-Er) 308, router (R2) 104 parses it and removes the BGP fixed size header 400 in step 1004. By examining the Type field 406 of the BGP fixed sized header 400, which is encoded with the value “6”, it is determined that the BGP-ICMP echo reply message (P2-Er) 308 is of the type OVERLAY_PROTOCOL so processing moves on to step 1012. In step 1012, the BGP overlay message header, including the Layer field (L) 502 and Protocol field 504, is parsed and removed. Next, in step 1014, it is determined that the value “1” is encoded in the Layer field (L) 502, signifying that the embedded overlay protocol traditionally runs atop the IP layer, so processing moves on to step 1022. In step 1022, by parsing the Protocol field 504, it is determined that it is encoded with the value “1”. In step 1024, it is determined that the value “1” encoded in the Protocol field 504 signifies that the embedded overlay protocol is ICMP.

In step 1020, the remaining portion of the message, the ICMP message 801, is processed as an ICMP message. As part of that processing, the Type field 802, which is encoded with the value “0”, and the Code field 804, which is encoded with the value “0”, are parsed and, based on their encoded values, the router (R2) 104 determines that the ICMP packet 801 is an ICMP echo reply message. Upon determining that the ICMP packet 801 is an ICMP echo reply message, a timestamp (T3) is encoded at router (R2) 104 recording the time the BGP-ICMP echo reply message (P2-Er) 308 is processed. Next, the Identifier field 808 and Sequence Number field 810 are parsed and their values are compared to values of the Identifier field 808 and Sequence Number field 810 of the ICMP echo request message sent earlier by router (R2) 104 to match the reply to the request. Once the reply and request messages have been matched, router (R2) 104 can calculate the overall, end-to-end delay/latency as (T3−T1)/2.

In another embodiment, the overall, one-way latency of a BGP packet can be determined using ICMP timestamp and ICMP timestamp-reply messages as the payload in an embedded overlay protocol BGP message. Unlike the embodiment using the ICMP echo request and echo reply messages, when using the ICMP timestamp and timestamp-reply messages, both routers (R2 and R5) 104, 106 should be time synchronized. In one embodiment, a time synchronization protocol (i.e. NTP, PTP, or the like) is used to perform the time synchronization. With time synchronization, router (R2) 104 can accurately determine the latency of BGP packets sent from router (R2) 104 to router (R5) 106 as the difference between when the ICMP timestamp message is sent by router (R2) 104 and when it is handed over for processing to R5 BGP 230.

Similar to the example embodiment described above, this example embodiment uses a version of the ICMP protocol embedded in the network control protocol BGP as an overlay protocol. In this example, ICMP packets, such as the timestamp and timestamp reply messages, can be exchanged as payloads of BGP packets. As such, the BGP packets carry the embedded ICMP packets and are exchanged between routers (R2) 104 and (R5) 106 in the same manner as regular BGP control protocol packets. Using the ICMP features described above with respect to FIG. 3, latency measurements based on the embedded ICMP packets will account for the BGP and TCP portions of the total, one-way latency of BGP control protocol packets. In this way, it becomes possible to easily and accurately measure the total, one-way latency of BGP packets. Alternatively, the ICMP protocol can be embedded into other network control protocols such as LDP, OSPF, IS-IS, RSVP-TE, to name a few, to easily and accurately measure the total, one-way latency of any of these other network control protocols, making the embodiments described herein a generic mechanism for measuring the total, one-way latency of almost any network control protocol.

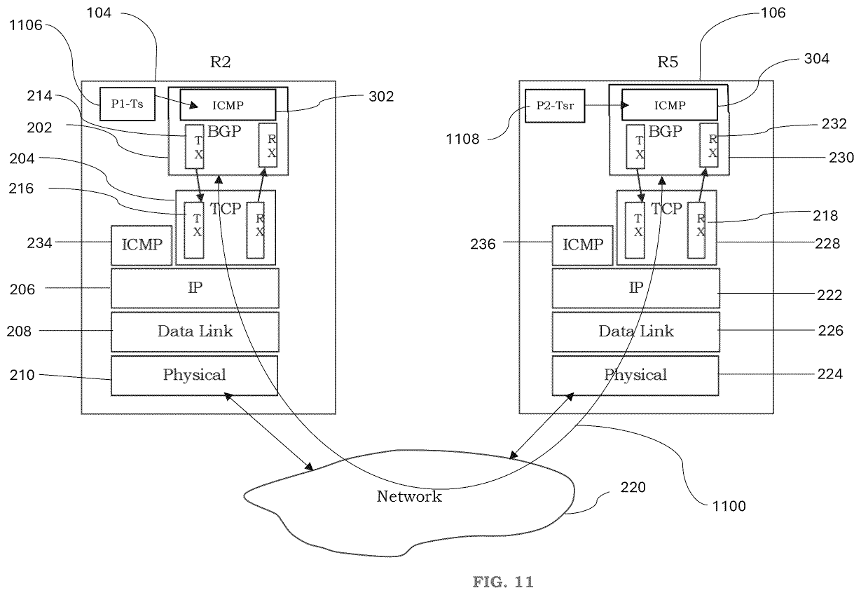

Referring now to FIG. 11, another example of a BGP peering session 1100 between routers (R2) 104 and (R5) 106 is illustrated. BGP 202, 230 in peering session 1100 uses TCP 204, 228 as the transport layer protocol which, in turn, runs atop the IP layer (IPv4 or IPv6) 206, 222. IP 206, 222 runs atop corresponding data link layers 208, 226 such as Ethernet. Physical layers 210, 224 provide the physical media to transport ethernet frames. In this example, BGP peering session 1100 is configured to calculate the one-way, overall latency according to an example embodiment.

In BGP peering session 1100, the BGP protocol 202, 230 of each router (R2) 104 and (R5) 106 includes an embedded instance of the ICMP protocol 302, 304. In this embodiment, an embedded ICMP packet is sent and received as the payload of a BGP packet such that the embedded ICMP packet travels across the same route and experiences the same delays/latencies as any other BGP packet exchanged between routers (R2) 104 and (R5) 106.

This embodiment uses BGP-ICMP-timestamp (P1-Ts) 1106 to denote the ICMP timestamp message (Ts) embedded inside a BGP packet (P1) and BGP-ICMP-timestamp-reply (P2-Tsr) 1108 to denote the ICMP timestamp reply message (Tsr) embedded inside a BGP packet (P2). Both the ICMP timestamp and ICMP timestamp-reply messages include the tuple {orig-ts, rx-ts, tx-tsr} wherein orig-ts represents a timestamp indicative of the time originating BGP-ICMP timestamp message (P1-Ts) 1106 is sent, rx-ts represents a timestamp indicative of the time the BGP-ICMP timestamp message (P1-Ts) 1106 is received at R5 BGP 230 for processing, and tx-tsr represents a timestamp indicative of the time the return BGP-ICMP timestamp-reply message (P2-Tsr) 1108 is sent.

Following a sequence similar to the one shown in FIG. 2 for the exchange of any BGP packet between routers (R2) 104 and (R5) 106, router (R2) 104 generates a BGP-ICMP-timestamp message (P1-Ts) 1106 to router (R5) 106 at time T1 and router (R2) 104 sets orig-ts in the ICMP timestamp message (P1-Ts) 1106 to T1. The exchange of BGP-IMCP-timestamp message (P1-Ts) 1106 involves at least the following sequence:
At the beginning of the exchange timeline, router (R2) 104 generates the BGP-ICMP-timestamp message (P1-Ts) 1106 to router (R5) 106 at time T1. Router (R2) 104 sets orig-ts in the BGP-ICMP-timestamp message (P1-Ts) 1106 to T1 and then enqueues the BGP-ICMP-timestamp message (P1-Ts) 1106 into its BGP internal transmit queue 214.
After a delay/latency of L-bgp-tx, BGP-ICMP-timestamp message (P1-Ts) 1106 is dequeued from the BGP transmit queue 214 and inserted into the TCP transmit queue 216.
After a delay/latency of L-tcp-tx, BGP-ICMP-timestamp message (P1-Ts) 1106 is dispatched by router (R2) TCP 204 with the embedded BGP-ICMP-timestamp message (P1-Ts) 1106 configured as an IP packet.
The IP packet, including the embedded BGP-ICMP-timestamp message (P1-Ts) 1106, is transmitted from router (R2) 104 to router (R5) 106 via the network 220. Eventually, the BGP-ICMP-timestamp message (P1-Ts) 1106 reaches the (R5) IP layer 222. The total propagation delay of the IP packet from router (R2) 104 to router (R5) is L-ip-tx. Upon reaching the (R5) IP layer 222, the BGP-ICMP-timestamp message (P1-Ts) 1106 is enqueued to the (R5) TCP receive queue 218.
After a delay/latency of L-tcp-rx, the BGP-ICMP-timestamp message (P1-Ts) 1106 is dequeued from TCP receiving queue 218 by router (R5) BGP 230. BGP 230 may further enqueue BGP-ICMP-timestamp message (P1-Ec) 1106 to the (R5) internal BGP receiving queue 232.
After a delay/latency of L-bgp-rx, BGP-ICMP-timestamp message (P1-Ts) 1106 is processed by router (R5) BGP protocol 230. While processing the BGP-ICMP-timestamp message (P1-Ts) 1106, BGP 230 finds that the payload of the BGP-ICMP-timestamp message (P1-Ts) 1106 is an ICMP timestamp message, so the BGP 230 hands over the payload ICMP timestamp message to the instance of the ICMP protocol 304 embedded in BGP 230 at time T2.

In this exchange, the total delay/latency for the BGP-ICMP-timestamp message (P1-Ts) 1106 (L-P1-Ec−total) is: L-P1-Ts−total=L-bgp-tx+L-tcp-tx+L-ip-tx+L-tcp-rx+L-bgp-rx, which is the same as L-bgp (i.e. the latency of any other BGP packet sent from router (R2) 104 to router (R5) 106).

At this point, router (R5) 106 could determine the delay/latency for a BGP message to travel from router (R2) 104 to router (R5) as the difference between T2 (the time the payload of BGP-ICMP-timestamp message 1106 is handed over for processing by R5 BGP 230 to the instance of ICMP protocol 304 embedded in R5 BGP 230) and T1 (orig-ts in the BGP-ICMP-timestamp message (P1-Ts) 1106 which is the time the BGP-ICMP-timestamp message 1106 is sent by router (R2) 104).

Continuing the exchange, (R5) embedded ICMP instance 304, generates a BGP-ICMP-timestamp-reply message (P2-Tsr) 1108 in response to the received BGP-IMCP-timestamp message (P1-Ts) 1106 at time T3. Router (R5) encodes the {orig-ts, rx-ts, tx-tsr) as follows:
orig-ts=orig-ts from the original BGP-ICMP-timestamp message (P1-Ts) 1106 (i.e. T1);
tx-ts=local timestamp of when the payload (Ts) portion of the original BGP-ICMP-timestamp message (P1-Ts) 1106 is received for processing by the instance of ICMP embedded in R5 BGP 304 (i.e. T2); and
tx-tsr=local timestamp of when BGP-ICMP-timestamp-reply message (P2-Tsr) 1108 is sent by router (R5) 106 (i.e. T3).

The BGP-ICMP-timestamp-reply message (P2-Tsr) 1108 is dispatched from router (R5) 106 to router (R2) 104 in the reverse manner as BGP-ICMP-timestamp-message (P1-Ts) 1106 was transmitted from router (R2) 104 to router (R5) 106.

Eventually, (R2) BGP 202 receives and processes the BGP-ICMP-timestamp-reply message (P2-Tsr) 1108. While processing the BGP-ICMP-timestamp-reply message (P2-Tsr) 1108, (R2) BGP 202 finds that the message payload is an ICMP timestamp reply packet, so it hands over the payload to the embedded instance of the ICMP protocol 302 at time T4. The ICMP timestamp reply packet 801 is then processed by the embedded instance of ICMP protocol 302 and router (R2) 104 can use the information encoded in ICMP timestamp reply packet tuple as well as time T4 to calculate the various latencies for a BGP packet as follows:
the total, one-way latency from router (R2) 104 to router (R5) 106, OWL(r2−r5)=T2−T1;
the total, one-way latency from router (R5) 106 to router (R2) 104, OWL(r5−r2)=T4−T3; and
the total, round trip latency, RTL(r2−r5−r2)=OWL(r2−r5)+OWL(r5−r2).

Referring again to FIG. 4, another example embodiment, using the ICMP timestamp and timestamp reply messages embedded in an overlay protocol message inside of a BGP packet, is described. The fixed sized header of a BGP packet for this embodiment is similar to the ICMP echo embodiment described above. In the BGP fixed sized header, the Marker field 402 is set to all ones, the Length field 404, which is a 2-octet unsigned integer indicating the total length of the message, including the header, in octets should be at least 19 and usually no greater than 4096 and is set as the smallest value required, given the rest of the message. As described above with respect to the ICMP echo example, the Type field 406 is set to “6” to indicate that this is a new type of BGP message (“OVERLAY_PROTOCOL”). As mentioned above, while, for the purposes of this disclosure we have set the Type field 406 to “6”, any available new message type value (a value greater than “5”) could be assigned to this new message type. Message type “OVERLAY_PROTOCOL” indicates that the payload of the message (i.e. the data following the fixed header) includes messages for another protocol.

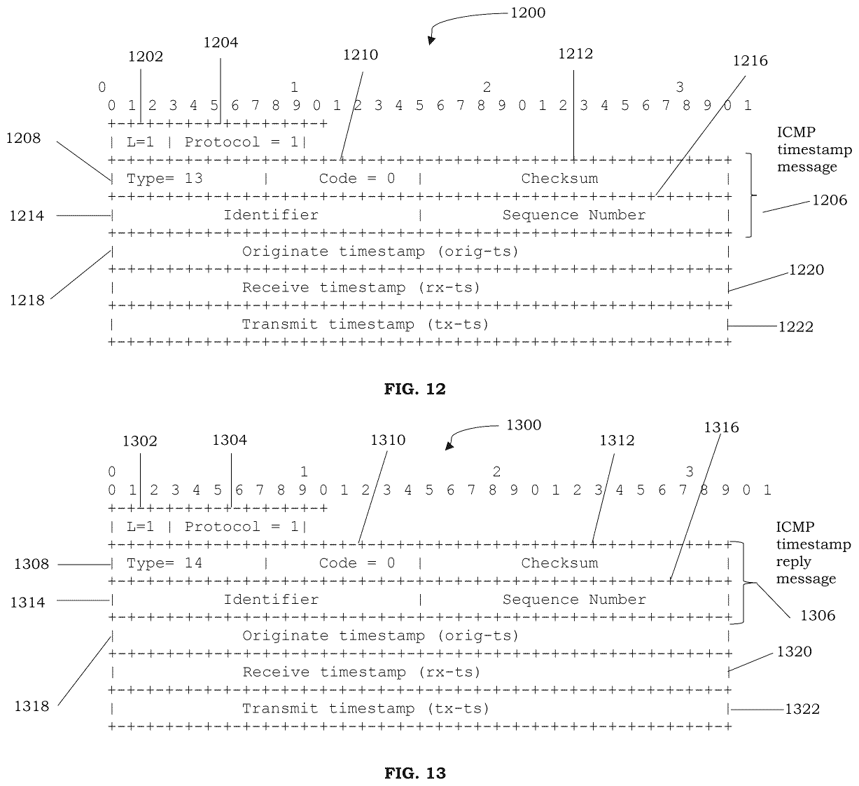

An example embodiment of the format of an “OVERLAY_PROTOCOL” message that can be sent as the payload following the fixed-sized BGP header 400 is illustrated in FIG. 12.

As shown in FIG. 12, this embodiment of an “OVERLAY_PROTOCOL” message 1200 includes a Layer field (L) 1202 and a Protocol field 1204, and as well as an ICMP timestamp message 1206 embedded in the Protocol Specific Message Format field (506 in FIGS. 5 and 7) of a BGP packet and three fields following the Protocol Specific Message Format field containing information specific to the ICMP timestamp message. In this embodiment, the Layer field (L) 1202 is set to “1” to indicated that the embedded overlay protocol (ICMP) is a standard protocol that traditionally operates atop the IP layer. The Protocol field 1204, which can be variable in length and can be configured to encode a protocol ID value indicative of the protocol type that is embedded in the message 1200, is set to “1” to indicate that the embedded overlay protocol is ICMP.

As shown in FIG. 12, the ICMP timestamp message 1206, which includes 8 fields, is embedded in the BGP Protocol Specific Message Format field as payload. The 8 ICMP timestamp message fields include information specific to ICMP timestamp messages. The “Type” field 1208, which indicates the type of ICMP message being sent, is set to “13” to indicate that the embedded message is an ICMP timestamp message. The “Code” field 1210 is set to “0”, the 16-bit “Checksum” field 1212 is the 16 bit one's complement of the one's complement sum of the ICMP message starting with the ICMP “Type” field 1208. The “Identifier” and “Sequence Number” fields 1214, 1216 both include an identifier to aid in matching the ICMP timestamp and ICMP timestamp reply messages. Finally, following the fields comprising the Protocol Specific Message Format field, a truple containing the ICMP data specific to an ICMP timestamp message is included in the Originate timestamp (orig-ts), Receive timestamp (rx-ts), and Transmit timestamp (tx-ts) fields 1218, 1220, and 1222. In a similar manner, ICMP or other overlay protocol messages may be embedded with other network control protocols such as LDP, OSPF, IS-IS, RSVP-TE, to name a few.

Referring again to FIGS. 9 and 10, the overlay ICMP packet (ICMP timestamp message 1206) and the BGP peer to which the packet is to be sent (router (R5) 106) is provided as input to originating BGP peer, router (R2) 104, in step 902. Input ICMP timestamp message 1206 includes a Type field 1208 encoded with a value of “13” and a Code field 1210 encoded with a value of “0” to indicate that the input ICMP message 1206 is a timestamp message. The Checksum field 1212 is encoded with the 16-bit one's complement of the one's complement sum of the input ICMP message 1206 starting with the Type field 1208. The Identifier field 1214 and Sequence Number field 1216, shown divided into a Big Endian (BE) value and a Little Endian (LE) value, are encoded with values used to link the timestamp packet (from router (R2) 104) to the timestamp reply packet (from router (R5) 106). For the purposes of the illustrated embodiment, the input Identifier field 1214 and Sequence Number field 1216 are encoded with the following:
Identifier (BE): 20731 (0x50ffb)
Identifier (LE): 64336 (0xfb50)
Sequence Number (BE): 0 (0x0000)
Sequence Number (LE): 0 (0x0000)

During step 904, it is determined that the input embedded overlay protocol packet is ICMP which traditionally runs atop the IP layer so the process of building the BGP overlay message header for an embedded overlay protocol that is not a standard ethernet based protocol begins. In step 918, the Layer field (L) 1202 in the BGP overlay message header is set to a value of “1” to indicate that the input embedded overlay protocol packet is not a standard ethernet based protocol and in step 920, the Protocol field 1204 in the BGP overlay message header is set to a value of “1” to indicate that the embedded overlay protocol is ICMP. Once the Layer field (L) 1202 and Protocol field 1204 have been encoded, the ICMP timestamp message 1206 is encapsulated in the BGP overlay message header in step 922 to form the ICMP “OVERLAY_PROTOCOL” message 1200.

After that, the BGP message fixed-size header 400, including the Marker 402, Length 404, and Type 406 fields is assembled in Step 912. As previously described, the Marker field 402 is set to all ones, the Length field 404 is set to reflect the total length of the message, including the header, and the Type field 406 is encoded with a type number reserved for new types of messages, such as “6” in the embodiment described herein, to indicate that the payload of the BGP message includes a message for another protocol (i.e. it isn't one of the original 5 BGP message types, instead it is a “new” message type). Once the BGP message fixed-size header 400 is assembled, the ICMP “OVERLAY_PROTOCOL” message 1200 is encapsulated with the assembled BGP fixed-size header 400 in step 914 to form the BGP-ICMP timestamp message (P1-Ts) 1106. As the BGP-ICMP timestamp message (P1-Ts) 1106 is about to be sent from router (R2) 104 to the router (R5) 106 in step 916, router (R2) 104 sets the Originate timestamp (orig-ts) field 1218 of the ICMP timestamp message tuple {orig-ts, rx-ts, tx-tsr} with a timestamp (T1) denoting the time the BGP-ICMP-timestamp message (P1-Ts) 1106 is dispatched to router (R5) 106 to form a completed BGP-ICMP-timestamp message (P1-Ts) 1106 and the message is dispatched.

The BGP-ICMP timestamp message (P1-Ts) 1106 travels through the network 220 until it reaches its destination, router (R5) 106. Once the BGP-ICMP timestamp message (P1-Ts) 1106 reaches router (R5) 106, it is processed as follows.

The BGP-ICMP timestamp message (P1-Ts) 1106 and identity of the sending BGP peer (router (R2) 104) are delivered as inputs to router (R5) 106 in step 1002. Upon receiving the BGP-ICMP timestamp message (P1-Ts) 1106, router (R5) 106 parses it and removes the BGP fixed size header 400 in step 1004. By examining the Type field 406 of the BGP fixed sized header 400, which is encoded with the value “6”, it is determined that the BGP-ICMP timestamp message (P1-Ts) 1106 is of the type OVERLAY_PROTOCOL and processing moves on to step 1012. In step 1012, the BGP overlay message header, including the Layer field (L) 1202 and Protocol field 1204, is parsed and removed. Next, in step 1014, it is determined that the value “1” is encoded in the Layer field (L) 1202, signifying that the embedded overlay protocol traditionally runs atop the IP layer, so processing moves on to step 1022. In step 1022, by parsing the Protocol field 1204, it is determined that the Protocol field 1204 is encoded with the value “1”. In step 1024, it is determined that the value “1” encoded in the Protocol field 1204 signifies that the embedded overlay protocol is ICMP.

In step 1020, the remaining portion of the message, the ICMP timestamp message 1206, is processed as an ICMP message. As part of that processing, the Type field 1208, which is encoded with the value “13”, and the cCode field 1210, which is encoded with the value “0”, are parsed. Based on their encoded values, the router (R5) 106 determines that the ICMP message 1206 is an ICMP timestamp message. Router (R5) 106 encodes a timestamp T2 denoting the time the BGP-ICMP timestamp message (P1-Ts) 1106 is passed to the instance of ICMP 304 embedded in R5 BGP 230 so that the Receive timestamp (rx-ts) field of a corresponding ICMP timestamp reply message tuple {orig-ts, rx-ts, tx-tsr} can be set to T2 and the process of responding with an ICMP timestamp reply message begins.

Referring now to FIG. 13, an example embodiment of the format of an “OVERLAY_PROTOCOL” message (includes a ICMP timestamp reply message) that can be sent as the payload following a fixed-sized BGP header 400 is illustrated. As shown in FIG. 13, this embodiment of an “OVERLAY_PROTOCOL” message 1300 includes a Layer field (L) 1302 and a Protocol field 1304, and as well as an ICMP timestamp reply message 1306 embedded in the Protocol Specific Message Format field (506 in FIGS. 5 and 7) of a BGP packet and three fields following the Protocol Specific Message Format field containing information specific to the ICMP timestamp reply message. In this embodiment, the Layer field (L) 1302 is set to “1” to indicate that the embedded overlay protocol (ICMP) is a standard protocol that traditionally operates atop the IP layer. The Protocol field 1304, which can be variable in length and can be configured to encode a protocol ID value indicative of the protocol type that is embedded in the message 1300, is set to “1” to indicate that the embedded overlay protocol is ICMP.

As shown in FIG. 13, the ICMP timestamp reply message 1306, which includes 8 fields, is embedded in the BGP Protocol Specific Message Format field as payload. The 8 ICMP timestamp reply message fields include information specific to ICMP timestamp reply messages. The “Type” field 1308, which indicates the type of ICMP message being sent, is set to “14” to indicate that the embedded message is an ICMP timestamp reply message. The “Code” field 1310 is set to “0”, the 16-bit “Checksum” field 1312 is set to the 16 bit one's complement of the one's complement sum of the ICMP timestamp reply message starting with the ICMP “Type” field 1308. The “Identifier” and “Sequence Number” fields 1314, 1316 both include an identifier to aid in matching the ICMP timestamp reply message 1306 to the originating ICMP timestamp message 1206. Finally, following the fields comprising the Protocol Specific Message Format field, a truple containing the ICMP data specific to an ICMP timestamp reply message is included in the Originate timestamp (orig-ts), Receive timestamp (rx-ts), and Transmit timestamp (tx-ts) fields 1318, 1320, and 1322. In a similar manner, ICMP or other overlay protocol messages may be embedded with other network control protocols such as LDP, OSPF, IS-IS, RSVP-TE, to name a few.

The process of responding to the ICMP timestamp message from router (R2) 104 begins by supplying an embedded overlay protocol packet (ICMP Message in the form of an ICMP timestamp reply message 1306) and the BGP peer to which the packet is to be sent (router (R2) 104) as input to router (R5) 106 in step 902. The input ICMP Message 1306 includes a Type field 1308 encoded with a “14” and a Code field 1310 encoded with a “0” to indicate that the input ICMP message 1306 is an ICMP timestamp reply message. The Checksum field 1312 is encoded with the 16-bit one's complement of the one's complement sum of the input ICMP message 1306 starting with the Type field 1308. The Identifier field 1314 and Sequence Number field 1316 are both encoded with values used to link the timestamp reply packet to the timestamp packet received from router (R2) 104. In order to do so, the input Identifier field 1314 and Sequence Number field 1316 are encoded with the same values as those encoded in the timestamp message received from router (R2) 104, namely:
Identifier (BE): 20731 (0x50ffb)
Identifier (LE): 64336 (0xfb50)
Sequence Number (BE): 0 (0x0000)
Sequence Number (LE): 0 (0x0000)

During step 904, it is determined that the input embedded overlay protocol packet is ICMP which traditionally runs atop the IP layer so the process of building the BGP overlay message header for an embedded overlay protocol that is not a standard ethernet based protocol begins. In step 918, the Layer field (L) 1302 in the BGP overlay message header is set to a value of “1” to indicate that the input embedded overlay protocol packet is not a standard ethernet based protocol and in step 920, the Protocol field 1310 in the BGP overlay message header is set to a value of “1” to indicate that the embedded overlay protocol is ICMP. Once the Layer field (L) 1302 and Protocol field 1310 have been encoded, the ICMP timestamp reply message 1306 is encapsulated in the BGP overlay message header in step 922 to form the ICMP “OVERLAY_PROTOCOL” message 1300.

After that, the BGP message fixed-size header 400, including the Marker 402, Length 404, and Type 406 fields, is assembled in Step 912. As previously described, the Marker field 402 is set to all ones, the Length field 404 is set to reflect the total length of the message, including the header, and the Type field 406 is encoded with a type number reserved for new types of messages, such as “6” in the embodiment described herein, to indicate that the payload of the BGP message includes a message for another protocol (i.e. it isn't one of the original 5 BGP message types, instead it is a “new” message type). Once the BGP message fixed-size header 400 is assembled, the ICMP “OVERLAY_PROTOCOL” message 1300 is encapsulated with the assembled BGP fixed-size header 400 in step 914. As the BGP-ICMP timestamp replay message (P2-Tsr) 1108 is about to be sent from router (R5) 106 to the router (R2) 104, router (R5) 106 sets the Originate timestamp (orig-ts) field 1318 of the ICMP timestamp reply message tuple {orig-ts, rx-ts, tx-tsr} to timestamp (T1), the Receive timestamp (rx-ts) field 1320 to timestamp (T2), and encodes the Transmit timestamp (tx-tsr) field 1322 with a timestamp T3 which denotes the time the BGP-ICMP-timestamp reply message (P2-Tsr) 1108 is dispatched from router (R5) 106 to router (R2) 104 to form a completed BGP-ICMP-timestamp reply message (P2-Tsr) 1108. The completed BGP-ICMP timestamp reply message (P2-Tsr) 1108 is sent from router (R5) 106 to the router (R2) 104 in step 916.

The completed BGP-ICMP timestamp reply message (P2-Tsr) 1108 travels across the network 220 until it reaches router (R2) 104. Upon receiving the BGP-ICMP timestamp reply message (P2-Tsr) 1108, router (R2) 104 begins processing the message as follows.

The BGP-ICMP timestamp reply message (P2-Tsr) 1108 and identity of the sending BGP peer, router (R5) 106, are delivered as inputs to receiving router (R2) 104 in step 1002. Upon receiving the BGP-ICMP timestamp reply message (P2-Tsr) 1108, router (R2) 104 parses it and removes the BGP fixed size header 400 in step 1004. By examining the Type field 406 of the BGP fixed sized header 400, which is encoded with the value “6”, it is determined that the BGP-ICMP timestamp reply message (P2-Tsr) 1108 is of the type OVERLAY_PROTOCOL so processing moves on to step 1012. In step 1012, the BGP overlay message header, including the Layer field (L) 1302 and Protocol field 1304, is parsed and removed. Next, in step 1014, it is determined that the value “1” is encoded in the Layer field (L) 1302, signifying that the embedded overlay protocol traditionally runs atop the IP layer, so processing moves on to step 1022. In step 1022, by parsing the Protocol field 1304, it is determined that it is encoded with the value “1”. In step 1024, it is determined that the value “1” encoded in the Protocol field 1304 signifies that the embedded overlay protocol is ICMP.

In step 1020, the remaining portion of the message, the ICMP message 1306, is processed as an ICMP message. As part of that processing, the Type field 1308, which is encoded with the value “14”, and the Code field 1310, which is encoded with the value “0”, are parsed and, based on their encoded values, the router (R2) 104 determines that the ICMP message 1306 is an ICMP timestamp reply message. Next, the Identifier field 1314 and Sequence Number field 1316 are parsed and their values are compared to values of the Identifier field 1214 and Sequence number field 1216 of the ICMP timestamp message sent earlier by router (R2) 104 to match the timestamp reply message to the original timestamp message. Router (R2) 104 encodes a timestamp (T4) recording the time the BGP-ICMP timestamp reply message (P2-Tsr) 1108 was processed and then router (R2) 104 can calculate:
the overall, one-way delay/latency of BGP packets sent from router (R2) 104 to router (R5) 106 as OWL(r2−r5)=rx-ts (T2)−orig-ts (T1);
the overall, one-way delay/latency of BGP packets sent from router (R5) 106 to router (R2) 104 as OWL(r5−r2)=T4-tx-tsr (T3); and
the overall, end-to-end delay/latency from router (R2) 104 to router (R5) 106 and back to router (R2) 104 as RTL (r2−r5−r2)=OWL(r2−r5)+OWL (r5−r2).

In addition to ICMP, other protocols, such as One-Way Active Measurement Protocol (OWAMP) and Two-Way Active Measurement Protocol (TWAMP), provide tools for measuring latency. OWAMP comprises two inter-related protocols: OWAMP-Control and OWAMP-Test. OWAMP-Control is traditionally layered over TCP and can be used to, among other things, initiate and control measurement sessions or to fetch their results. OWAMP-Test is traditionally layered over UDP and can be used to, among other things, send singleton measurement packets along an Internet path under test. Typically, OWAMP servers listen to a well-known port, such as 861, and the initiator of the measurement session establishes a TCP connection to this port on the target point. The TCP connection usually remains open for the duration of the OWAMP-Test sessions. OWAMP-Control messages are usually only transmitted before OWAMP-Test sessions are started and after they are completed (an early Stop-Sessions message being one exception to this rule). In various example embodiments, OWAMP-Control messages can be sent on TCP and each TCP segment can be embedded as payload of a BGP packet. OWAMP-Test messages can be sent on UDP and each UDP packet can be embedded as payload of a BGP packet.

Also similar to ICMP, OWAMP messages can be embedded as the payload in a network control protocol message and used to determine the end-to-end latency of network control protocol packets sent between nodes in a network. In this embodiment, an OWAMP-Test message, which includes a timestamp field, can be embedded as the payload of a BGP message and used for calculating latency. With time synchronization, the latency of BGP packets sent from one network node to another can be calculated as the difference between when the embedded OWAMP Test message is sent by the source node and when it is handed over for processing to an instance of OWAMP opened in the network control protocol (BGP) at the destination node.

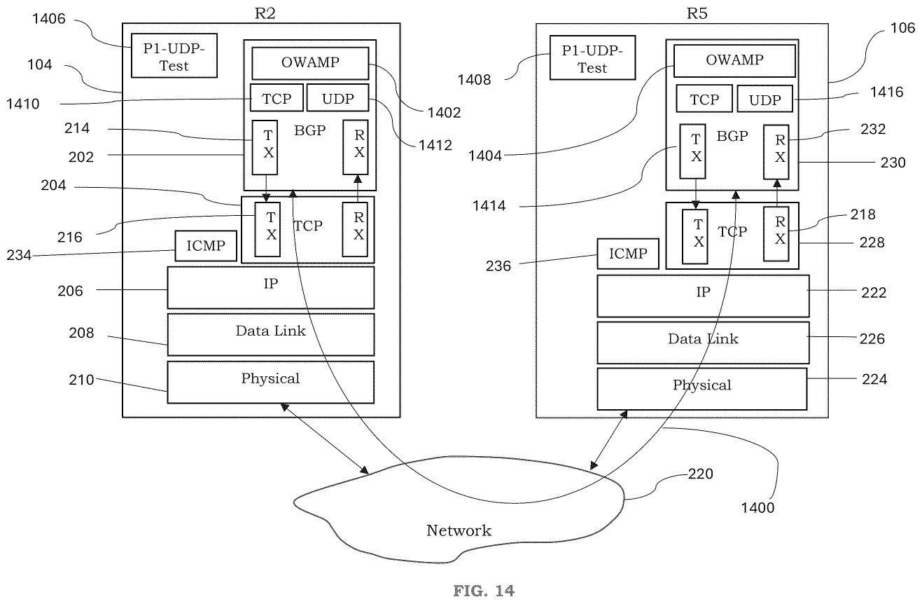

Referring now to FIG. 14, another example of a BGP peering session 1400 between routers (R2) 104 and (R5) 106 is illustrated. BGP 202, 230 in peering session 1400 uses TCP 204, 228 as the transport layer protocol which, in turn, runs atop the IP layer (IPv4 or IPv6) 206, 222. IP 206, 222 runs atop data link layers 208, 226 such as Ethernet. Physical layers 210, 224 provides the physical media to transport ethernet frames. In this example, BGP peering session 1400 is configured to calculate the one-way, overall latency using an embedded OWAMP message according to an example embodiment.

In BGP peering session 1400, the BGP protocol 202, 230 of each router (R2) 104 and (R5) 106 includes embedded instances of OWAMP 1402, 1404, TCP 1410, 1414, and UDP 1412, 1416. In this embodiment, an OWAMP-Test message embedded in a UDP packet can be sent and received as payload of a BGP packet such that the embedded OWMAP-Test message travels across the same route and experiences the same delays/latencies as any other BGP packet exchanged between routers (R2) 104 and (R5) 106.

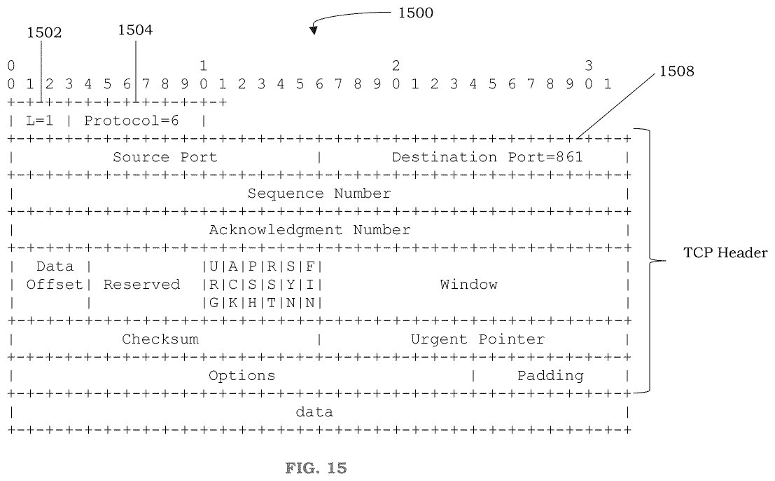

However, before the embedded OWAMP-Test message can be sent, the client side OWAMP 1402 opens an “overlay” TCP connection to the server on well-known port 861 using an instance of TCP 1410 embedded in R2 BGP 202. The TCP segments exchanged for the overlay TCP connection can be transmitted as payloads of BGP messages. An example “OVERLAY PROTOCOL” message 1500 comprising a TCP connection establishment packet embedded as the payload of a BGP message is illustrated in FIG. 15. In this embodiment, the Layer field (L) 1502 is set to “1” to indicate that the embedded overlay protocol, TCP in this case, traditionally runs atop the IP layer, the Protocol field 1504 is encoded with a value of “6” to indicate that the embedded overlay protocol is TCP, and the Destination Port field 1508 is set to a value of “861” to indicate that the message destination is server port 861.

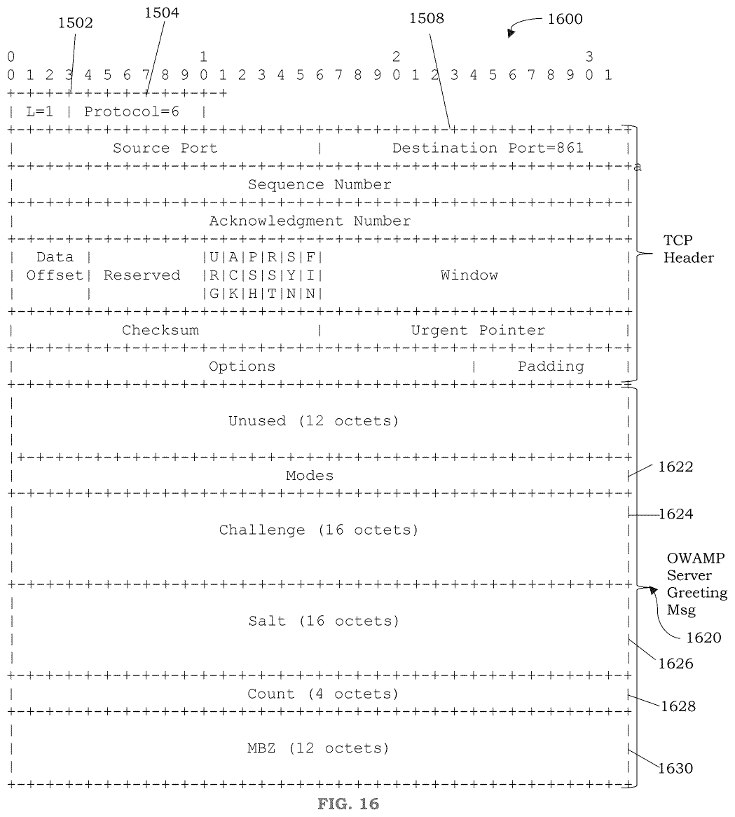

Once the overlay TCP connection is established atop BGP peering session 1400, an OWAMP test session can be established by exchanging OWAMP-Control packets over the overlay TCP connection. When the overlay TCP connection is established, the TCP server side responds with a Server Greeting message (a type of OWAMP-Control packet). An example embodiment of an “OVERLAY PROTOCOL” message 1600 comprising a Server Greeting message embedded in TCP which is further embedded as the payload of a BGP overlay message is illustrated in FIG. 16.

The OWAMP Server Greeting message 1620 that is embedded in TCP which is further embedded as the payload of a BGP overlay message, includes a Modes field 1622, a Challenge field 1624, a Count field 1628, and a MBZ field 1630. The Modes field 1622 is a 32-bit field with the value of the Modes field sent by the server being a bit-wise OR of the modes values that it is willing to support during this session. The first 29 bits of the Modes field 1622 are set to “0” and, thus, are ignored. These bits can be made available for future protocol extension.

However, the last three bits of the Modes field 1622 value convey information. For the purposes of this embodiment, the relevant values are: 1 for unauthenticated; 2 for authenticated; and 4 for encrypted. The Challenge field 1624 is a random sequence of octets generated by the server which are subsequently used by the client to prove possession of a shared secret as described in more detail below. The Salt and Count fields 1626, 1628 are parameters used in deriving a key from the shared secret. The Salt field 1626 is generated pseudo-randomly to be independent of anything else. The Count field 1628 is a power of 2 and should be at least 1024. The Count field 1628 can be increased as more computing power becomes available and common.

If the Modes field 1622 value is “0”, the server does not wish to communicate with the client and may close the connection immediately. Generally speaking, the client should close the connection if it receives a greeting with the Modes field 1622 set to a value of “0”. The client may also decide to close the connection if the client's desired mode is unavailable. If the client does wish to proceed with the connection, it should respond with a Set-Up-Response message.

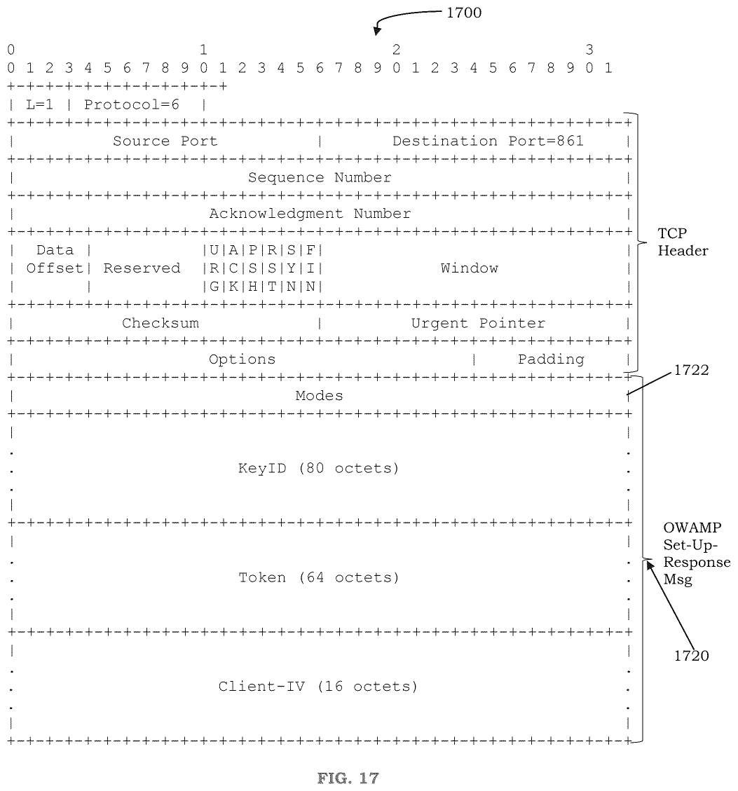

An example embodiment of an “OVERLAY PROTOCOL” message 1700 comprising an example Set-Up-Response message 1720 embedded in a TCP packet which is further embedded as the payload of a BGP message is illustrated in FIG. 17. In this example, the Modes field 1722 represents the mode that the client chooses to use during this OWAMP-Control session. It can also be used for all OWAMP-Test sessions started under control of this OWAMP-Control session. As described above, the first 29 bits of the Modes field 1722 should be set to zero and, because the last three bits of the Modes field 1722 convey information representative of the mode, they should be set to either one or zero. If one bit is set within the last three bits, the set bit should indicate a mode that the server agreed to use (i.e. the same bit should have been set by the server in the server greeting). Again. the first 29 bits of the Mode field 1722 are reserved for future protocol extension and thus can be ignored since they should be set to zero. If none of the Modes field 1722 bits are set by the client, the client indicates that it will not continue with the sessions. In this case, the client and the server should close the TCP connection associated with the OWAMP-Control session.

As described above, the Challenge field 1624 can be used by the client to prove possession of a shared secret and the Salt and Count fields 1626, 1628 can be used to derive a key from the shared secret. The shared secret can be a passphrase which should not contain newlines. The secret key can be derived from the passphrase using a password-based key derivation function such as PBKDF2 (Password-Based Key Derivation Function 2). PBKDF2 is part of RSA Laboratories'Public-Key Cryptography Standards (PKCS) series, specifically PKCS #5 (also published as IETF RFC 2898). The PBKDF2 key derivation function requires several parameters. In this example embodiment, the relevant parameters are the PRF, which, in this case, is a hash-based message authentication code (HMAC)—secure hash algorithm 1 (SHA1), and the Salt and Count parameters, which should be the same as the Salt field 1626 value and Count field 1628 value, respectively, transmitted by the server.

AES (Advanced Encryption Standard) Session-key, HMAC Session-key, and Client-IV can be randomly generated by the client. AES Session-key and HMAC Session-key should be generated with sufficient entropy not to reduce the security of the underlying cipher. Client-IV merely needs to be unique (i.e., it shouldn't be repeated for different sessions using the same secret key). One simple way to achieve uniqueness for the Client-IV is to generate Client-IV values using a cryptographically secure pseudo-random number source. If this is done correctly, the first repetition is unlikely to occur before 2⁶⁴ sessions with the same secret key are conducted. Upon receiving the Set-Up-Response message 1720, the server should respond with a Server-Start-message.

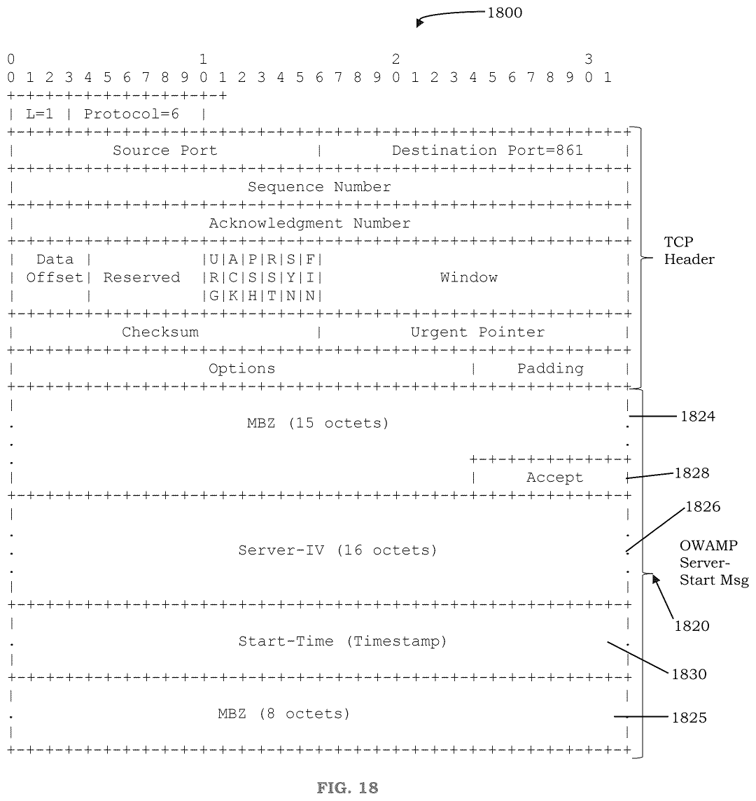

An example embodiment of an “OVERLAY PROTOCOL” message 1800 comprising an example Server-Start-message 1820 embedded in a TCP packet which is further embedded as the payload of a BGP message is illustrated in FIG. 18. In this example, the MBZ parts should be zero and the client should ignore their value. The MBZ (Must Be Zero) fields 1824, 1825 should have the same semantics as later MBZ fields: the party that sends the message should set the field so that all bits are equal to zero; the parts that interpret the message should ignore the value. This way, the field could be used for future extensions. The Server-IV field 1826 can be randomly generated by the server. In unauthenticated mode, the Server-IV field 1826 is usually unused.

The Accept field 1828 indicates the server's willingness to continue communication. A zero value in the Accept field 1828 indicates that the server accepts the authentication and is willing to conduct further transactions. Non-zero values indicate that the server does not accept the authentication or, for some other reason, is not willing to conduct further transactions in this OWAMP-Control session. If a negative (non-zero) response is sent, the server and client may close the connection after this message. The Start-Time field 1830 is a timestamp representing the time when the current instantiation of the server started operating. For example, in a multi-user general-purpose operating system, it could be the time when the server process was started. If the Accept field 1828 is non-zero, the Start-Time field 1830 should be set so that all of its bits are zeros. In authenticated and encrypted modes, the Start-Time field 1830 is usually encrypted, unless the Accept field 1828 is non-zero. Authenticated and encrypted mode usually cannot be entered unless the control connection can be initialized.

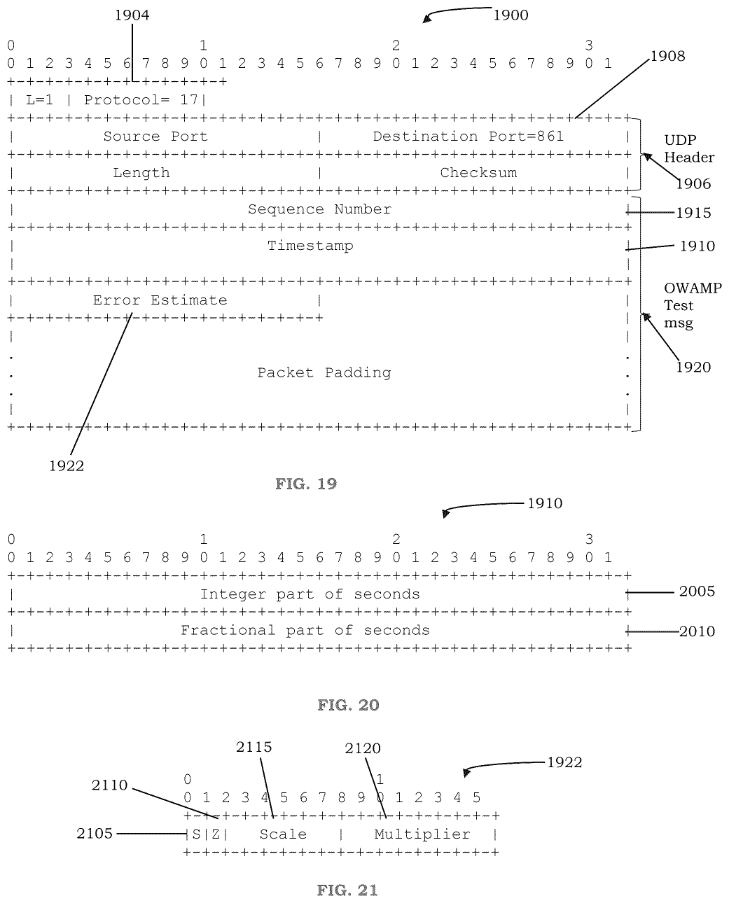

Once the OWAMP test session is established, the OWAMP-Test message can be used for the session to determine one-way latency. An example embodiment of an “OVERLAY PROTOCOL” message 1900 comprising an example OWAMP-Test message 1920 embedded in a UDP packet which is further embedded as the payload of a BGP message is illustrated in FIG. 19. The OWAMP-Test message 1920 is transmitted over UDP, which becomes the overall payload of the OVERLAY PROTOCOL message 1900 so, in this example, the Protocol field 1904 is encoded with a value of 17 to indicate the UDP header 1906. The Destination Port field 1908 in the UDP header 1906 is encoded with a value of 861 to indicate the UDP payload as an OWAMP message. The Timestamp field 1910 represents the time of the OWAMP-Test message and the Error Estimate field 1922 specifies an estimate of the error and synchronization. The Sequence Number field 1924 value should start with zero and should be incremented by one for each subsequent packet. The minimum data segment length is, therefore, 14 octets in unauthenticated mode, and 48 octets in both authenticated mode and encrypted mode.

An example embodiment of the format of the Timestamp field 1910 in the OWAMP-Test message 1920 is illustrated in FIG. 20. The first 32 bits 2005 represent the unsigned integer number of seconds elapsed since 0 H on 1 January 1900. The second 32 bits 2010 represent the fractional part of a second that has elapsed since then. An example embodiment of the format of the Error Estimate field 1922 in the OWAMP-Test message is illustrated in FIG. 21. The S bit 2105, in the Error Estimate field 1922 should be set if the party generating the timestamp has a clock that is synchronized to UTC using an external source (e.g., the bit should be set if GPS hardware is used and it indicated that it has acquired current position and time or if NTP is used and it indicated that it has synchronized to an external source, which includes stratum 0 source, etc.). If there is no notion of external synchronization for the time source, the S bit 2105 should not be set. The Z bit 2110 has similar semantics as the MBZ fields 1824, 1825 elsewhere (i.e., it should be set to zero by the sender and ignored by everyone else). The Scale field 2115 is a 6-bit field comprising an unsigned integer and the Multiplier field 2120 is an 8-bit unsigned integer. The error estimate can be calculated as Error Estimate (EE)=Multiplier*2\hat{ }(−32)*2\hat{ }Scale (in second). (Notation clarification: 2\hat{ }Scale is two to the power of Scale.) The value of the Multiplier field 2120 should not be set to zero. If the value of the Multiplier field 2120 is zero, the packet should be considered corrupt and discarded.

Referring again to FIG. 14, BGP-OWAMP-Test message (P1-UDP-Test) 1406 is used to denote the OWAMP-Test message (Test) embedded inside a UDP packet (UDP) further embedded in a BGP packet (P1). The OWAMP-Test message (Test) includes a timestamp field. Following a sequence similar to the one shown in FIG. 2 for the exchange of any BGP packet between routers (R2) 104 and (R5) 106, router (R2) 104 generates a BGP-OWAMP-Test message (P1-UDP-Test) 1406 to router (R5) 106 at time T1. The exchange of the BGP-OWAMP-Test message (P1-UDP-Test) 1406 involves at least the following sequence:
At the beginning of the exchange timeline, router (R2) 104 generates the BGP-OWAMP-Test message (P1-UDP-Test) 1406 to router (R5) 106 at time T1. Router (R2) 104 sets the OWAMP-Test message timestamp field to T1 and then enqueues the BGP-OWAMP-Test message (P1-UDP-Test) 1406 into its BGP internal transmit queue 214.
After a delay/latency of L-bgp-tx, BGP-OWAMP-Test message (P1-UDP-Test) 1406 is dequeued from the BGP transmit queue 214 and inserted into the TCP transmit queue 216.
After a delay/latency of L-tcp-tx, BGP-OWAMP-Test message (P1-UDP-Test) 1406 is dispatched by router (R2) TCP 204 with the embedded BGP-OWAMP-Test message (P1-UDP-Test) 1406 configured as an IP packet.
The IP packet, including the embedded BGP-OWAMP-Test message (P1-UDP-Test) 1406, is transmitted from router (R2) 104 to router (R5) 106 via the network 220. Eventually, the BGP-OWAMP-Test message (P1-UDP-Test) 1406 reaches the (R5) IP layer 222. The total propagation delay of the IP packet from router (R2) 104 to router (R5) is L-ip-tx. Upon reaching the (R5) IP layer 222, the BGP-OWAMP-Test message (P1-UDP-Test) 1406 is enqueued to the (R5) TCP receive queue 218.
After a delay/latency of L-tcp-rx, the BGP-OWAMP-Test message (P1-UDP-Test) 1406 is dequeued from TCP receiving queue 218 by router (R5) BGP 230. BGP 230 may further enqueue BGP-OWAMP-Test message (P1-UDP-Test) 1406 to the (R5) internal BGP receiving queue 232.
After a delay/latency of L-bgp-rx, BGP-OWAMP-Test message (P1-UDP-Test) 1406 is processed by router (R5) BGP protocol 230. While processing the BGP-OWAMP-Test message (P1-UDP-Test) 1406, BGP 230 finds that the payload of the BGP-OWAMP-Test message (P1-UDP-Test) 1406 is a UDP packet (UDP), so the BGP 230 hands over the payload UDP packet (UDP-Test) to the instance of the UDP 1416 embedded in BGP 230. The embedded UDP instance 1416 identifies the UDP packet (UDP-Test) as an OWMAP-Test message (Test), so the embedded instance of UDP 1416 hands over the OWMAP-Test message (Test) to the instance of OWMAP 1404 embedded in BGP 230 at time T2.

In this exchange, the total delay/latency for the BGP-OWAMP-Test message (P1-UDP-Test) 1406 (L-P1-UDP-Test−total) is: L-P1-UDP-test−total=L-bgp-tx+L-tcp-tx+L-ip-tx+L-tcp-rx+L-bgp-rx, which is the same as L-bgp (i.e. the latency of any other BGP packet sent from router (R2) 104 to router (R5) 106).

At this point, router (R5) 106 can determine the delay/latency for a BGP message to travel from router (R2) 104 to router (R5) as the difference between T2 (the time the payload of BGP-OWAMP-Test message (P1-UDP-Test) 1406 is handed to the instance of OWAMP protocol 1404 embedded in R5 BGP 230) and T1 (the timestamp field in the OWAMP-Test message (Test) which is the time the BGP-OWAMP-Test message (P1-UDP-Test) 1406 is generated by router (R2) 104).

OWAMP can be used bi-directionally to also measure the one-way latency between router (R5) 106 and router (R2) 104. For example, the one-way latency between router (R5) and router (R4) 104 could be measured by generating and sending a BGP-OWAMP-Test message from router (R5) 106 to router (R4) 104 in the reverse manner as described above. However, OWAMP does not accommodate round trip or two-way measurements.

Two-Way Active Measurement Protocol (TWAMP) provides tools for measuring various two-way metrics, such as round-trip latency, between network devices. TWAMP-Control, which is a derivative of the OWAMP-Control function, is one tool for measuring the round-trip latency of network packets between network devices. TWAMP-Control messages are similar in format and follow similar guidelines as OWAMP-Control. For example, test session creation follows the same procedures as described above with regard to OWAMP-Control. The TWAMP-Test protocol is similar to the OWAMP-Test protocol with the exception that the Session-Reflector transmits test packets to the Session-Sender in response to each test packet it receives.

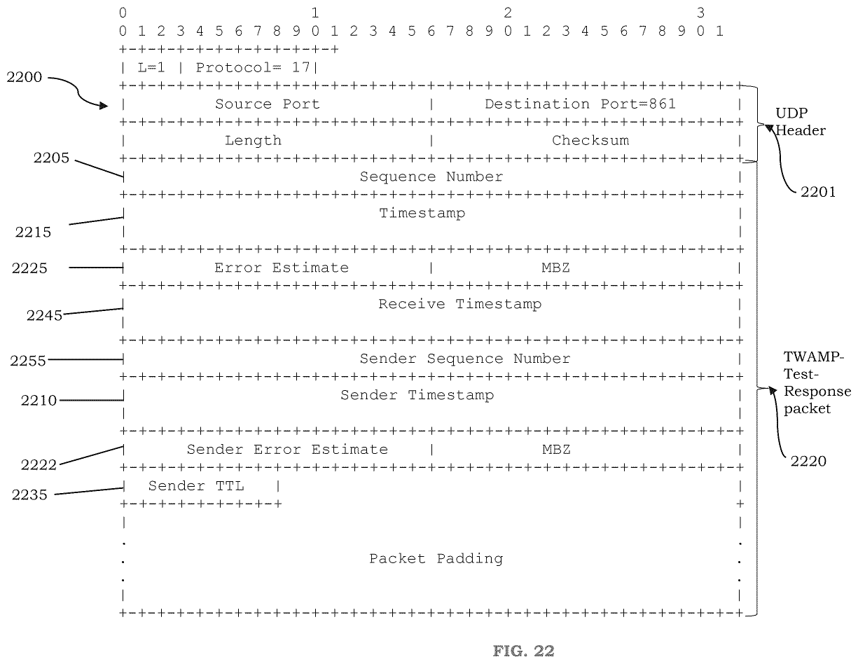

TWAMP defines two different test packet formats, one for packets transmitted by the Session-Sender and one for packets transmitted by the Session-Reflector. The Session-Sender sends a TWAMP-Test protocol packet using the same format as the OWAMP-Test packet shown in FIG. 19 and described above. FIG. 22 is an example embodiment of the format of a TWAMP-Test-Response packet sent by a Session-Reflector in response to receiving a TWAMP-Test message from a Session-Sender.

Referring now to FIG. 22, an example embodiment of an “OVERLAY PROTOCOL” message 2200 comprising an example TWAMP-Test-Response packet 2220 embedded in a UDP packet 2201 which is further embedded as the payload of a BGP message is illustrated. The TWAMP-Test Response packet 2220 includes a Sequence Number field 2205 which is the sequence number of the test packet according to its transmit order. It starts with zero and is incremented by one for each subsequent packet. The value of the Sequence Number field 2205 is generated by the Session Reflector (router (R5) 106 in our example embodiments) and is independent from the sequence number of the arriving packets. The Timestamp and Error Estimate fields 2215, 2225, are the Session-Reflector's transmit timestamp and error estimate, respectively, for the reflected test packet. The format of the Timestamp and Error Estimate fields, 2215, 2225 follow the same definition and formats as the corresponding OWAMP-Test fields 1910, 1922. The Sender Timestamp and Sender Error Estimate fields, 2210 and 2222, respectively, are copies of the Timestamp 1910 and Error Estimate 1922 fields from the Session-Sender test packet 1920 that corresponds to this TWAMP-Test-Response packet 2220. The Sender TTL field 2235 comprises the value 255 when transmitted by the Session Sender (router (R2) 104 in our example embodiments). The Sender TTL field 2235 is set to the time to live (or hop count) value of the received packet from the IP packet header when transmitted by the Session-Reflector. The Receive Timestamp field 2245 corresponds to the time the test packet 1920 is received by the instance of TWAMP running in BGP on the Session-Reflector. One-way latency between the Session-Sender (router (R2) 104) and Session-Receiver (router (R5) 106) can be calculated as the difference between the Receive Timestamp field 2245 and the Sender Timestamp field 2210.

The difference between the Timestamp field 2215 and Receive Timestamp field 2245 is the amount of time the packet was in transition (i.e. being processed by the instance of TWAMP running in BGP) in the Session-Reflector. The error estimate value associated with the Timestamp field 2215 also applies to the receive timestamp value. The Sender Sequence Number field 2255 is a copy of the Sequence Number field 1915 of the corresponding packet 1920 transmitted by the Session-Sender. The one-way latency between the Session-Receiver and the Session-Sender can be calculated as the difference between the Timestamp field 2215 and the time the TWAMP-Test-Response packet 2220 is received by the Session-Sender. The two-way, roundtrip latency between the Session-Sender and Session-Receiver can be calculated as the one-way latency between the Session-Sender and the Session-Receiver added to the one-way latency between the Session-Receiver and Session-Sender.

In a similar manner, ICMP, OWAMP, TWAMP, or the like overlay protocol messages may be embedded with any other network control protocol, such as LDP, OSPF, IS-IS, RSVP-TE and the like. Taking an example from the BGP embodiments described herein, one can implement techniques in other control protocols to embed other overlay protocols as well.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims. Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

The use of figure numbers and/or figure reference labels is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those of ordinary skill in the art that any block diagrams herein represent conceptual views of illustrative elements embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method for calculating latency between a first node and a second node running a network control protocol, the first node and the second node configured to send and receive a network control protocol message across a network, the method comprising:
at the first node, embedding an overlay protocol message as a payload to the network control protocol message to produce an embedded overlay protocol message;
sending the embedded overlay protocol message from the first node through the network to the second node;
recording a sent time (T1) indicative of a time the embedded overlay protocol message was sent;
receiving the embedded overlay protocol message at the second node;
processing the embedded overlay protocol message at the second node using an instance of an overlay protocol embedded in the network control protocol at the second node, the embedded overlay protocol being configured to process the embedded overlay protocol message;
at the second node, embedding an overlay protocol reply message as a payload to a second network control protocol message to produce an embedded overlay protocol reply message;
sending the embedded overlay protocol reply message from the second node through the network to the first node;
receiving the embedded overlay protocol reply message at the first node;
processing the embedded overlay protocol reply message at the first node using an instance of the overlay protocol embedded in the network control protocol at the first node;
recording a received time (T2) indicative of a time the embedded overlay protocol reply message is received by the instance of the overlay protocol embedded in the network control protocol at the first node; and
calculating the latency based on a difference between the received time (T2) and sent time (T1).

2. The method of claim 1, wherein the latency represents an estimation of a one-way latency between the first and second nodes and wherein calculating the latency further comprises dividing the difference between the received time (T2) and the sent time (T1) by two.

3. The method of claim 1, wherein the embedded overlay protocol further comprises Internet Control Message Protocol (ICMP), the embedded overlay protocol message further comprises an ICMP Echo Request message, and the embedded overlay protocol reply message further comprises an ICMP Echo Reply message.

4. The method of claim 1, wherein the embedded overlay protocol further comprises Two-Way Active Measurement Protocol (TWAMP), the embedded overlay protocol message further comprises a TWAMP-Test message, and the embedded overlay protocol reply message further comprises a TWAMP-Test Response message.

5. The method of claim 4, further comprising calculating the latency by subtracting the difference between the time the TWAMP-Test Response message is sent by the second node from a time the TWAMP-Test message is received by the instance of the TWAMP embedded in the network control protocol at the second node from the difference between the received time (T2) and the sent time (T1), wherein the first node and the second node are time synchronized and wherein the latency represents a two-way latency of a network control protocol message from the first node to the second node and back to the first node.

6. The method of claim 1, wherein the embedded overlay protocol further comprises Internet Control Message Protocol (ICMP), the embedded overlay protocol message further comprises an ICMP Timestamp message, and the embedded overlay protocol reply message further comprises an ICMP Timestamp Response message.

7. The method of claim 6, further comprising calculating the latency by subtracting the difference between the time the ICMP Timestamp Response message is sent by the second node from a time the ICMP Timestamp message is received by the instance of the TWAMP embedded in the network control protocol at the second node from the difference between the received time (T2) and the sent time (T1), wherein the first node and the second node are time synchronized and wherein the latency represents a two-way latency of a network control protocol message from the first node to the second node and back to the first node.

8. The method of claim 1, wherein the network control protocol further comprises Border Gateway Protocol (BGP).

9. A method for calculating one-way latency between a first node and a second node running a network control protocol, the first node configured to send and the second node configured to receive a network control protocol message across a network, the first node and second node being time synchronized, the method comprising:
at the first node, embedding an overlay protocol message as a payload to the network control protocol message to produce an embedded overlay protocol message;
sending the embedded overlay protocol message from the first node through the network to the second node, the embedded overlay protocol message including a sent time (T1) indicative of a time the embedded overlay protocol message was sent;
receiving the embedded overlay protocol message at the second node;
processing the embedded overlay protocol message at the second node using an instance of an overlay protocol embedded in the network control protocol at the second node, the embedded overlay protocol being configured to process the embedded overlay protocol message;
recording a received time (T2) indicative of a time the embedded overlay protocol message is received by the instance of the overlay protocol embedded in the network control protocol at the second node; and
calculating the one-way latency based on a difference between the received time (T2) and sent time (T1).

10. The method of claim 9, wherein the embedded overlay protocol further comprises One-Way Active Measurement Protocol (OWAMP) and the embedded overlay protocol message further comprises an OWAMP-Test message.

11. The method of claim 9, wherein the embedded overlay protocol further comprises Two-Way Active Measurement Protocol (TWAMP) and the embedded overlay protocol message further comprises a TWAMP-Test message.

12. The method of claim 9, wherein the embedded overlay protocol further comprises Internet Control Message Protocol (ICMP) and the embedded overlay protocol message further comprises an ICMP Timestamp message.

13. The method of claim 9, wherein the network control protocol further comprises Border Gateway Protocol (BGP).

14. A network node running a network control protocol and an instance of an overlay protocol embedded in the network control protocol, the network node configured to communicate with a second node across a network, the network node comprising:
at least one processor; and
at least one memory including program code; and
wherein the at least one memory and the program code are configured to, with the at least one processor, cause the network node at least to:
embed an overlay protocol message as a payload to a network control protocol message to produce an embedded overlay protocol message;
send the embedded overlay protocol message from the network node through the network to the second node,
encode the embedded overlay protocol message with a sent time (T1) indicative of a time the embedded overlay protocol message was sent from the network node to the second node;
receive an embedded overlay protocol reply message from the second node, the embedded overlay protocol reply message being sent by the second node in response to receiving the embedded overlay protocol message from the network node;
process the embedded overlay protocol reply message using the instance of the overlay protocol embedded in the network control protocol at the network node;
record a received time (T2) indicative of a time the embedded overlay protocol reply message is received by the instance of the overlay protocol embedded in the network control protocol at the network node; and
calculate latency between the network node and the second node based on a difference between the received time (T2) and sent time (T1).

15. The network node of claim 14, wherein the latency represents an estimation of a one-way latency between the network node and second node and wherein calculating the latency further comprises dividing the difference between the received time (T2) and the sent time (T1) by two.

16. The network node of claim 14, wherein the embedded overlay protocol further comprises Internet Control Message Protocol (ICMP), the embedded overlay protocol message further comprises an ICMP Echo Request message, and the embedded overlay protocol reply message further comprises an ICMP Echo Reply message.

17. The network node of claim 14, wherein the embedded overlay protocol further comprises Two-Way Active Measurement Protocol (TWAMP), the embedded overlay protocol message further comprises a TWAMP-Test message, and the embedded overlay protocol reply message further comprises a TWAMP-Test Response message.

18. The network node of claim 14, wherein the embedded overlay protocol further comprises Internet Control Message Protocol (ICMP), the embedded overlay protocol message further comprises an ICMP Timestamp message, and the embedded overlay protocol reply message further comprises an ICMP Timestamp Response message.

19. The network node of claim 14, wherein the network control protocol further comprises Border Gateway Protocol (BGP).

20. A network node running a network control protocol and an instance of an overlay protocol embedded in the network control protocol, the network node being time synchronized with a second node and configured to communicate with the second node across a network, the network node comprising:
at least one processor; and
at least one memory including program code; and
wherein the at least one memory and the program code are configured to, with the at least one processor, cause the network node at least to:
receive an embedded overlay protocol message from the second node, the embedded overlay protocol message comprising an overlay protocol message embedded as a payload to a network control protocol message the overlay protocol message being encoded with a sent time (T1) indicative of a time the second node sent the embedded overlay protocol message to the network node;
process the embedded overlay protocol message using the instance of the overlay protocol embedded in the network control protocol on the network node, the instance of the embedded overlay protocol being configured to process the embedded overlay protocol message;
record a received time (T2) indicative of a time the embedded overlay protocol message is received by the instance of the overlay protocol embedded in the network control protocol on the network node; and
calculate the one-way latency based on a difference between the received time (T2) and sent time (T1).

21. The network node of claim 20, wherein the embedded overlay protocol further comprises One-Way Active Measurement Protocol (OWAMP) and the embedded overlay protocol message further comprises an OWAMP-Test message.

22. The network node of claim 20, wherein the embedded overlay protocol further comprises Two-Way Active Measurement Protocol (TWAMP) and the embedded overlay protocol message further comprises a TWAMP-Test message.

23. The network node of claim 20, wherein the embedded overlay protocol further comprises Internet Control Message Protocol (ICMP) and the embedded overlay protocol message further comprises an ICMP Timestamp message.

24. The network node of claim 20, wherein the network control protocol further comprises Border Gateway Protocol (BGP).
